(19) United States
(12) Patent Application Publication
(10) Pub. No.: US 2013/0022720 A1
(43) Pub. Date: Jan. 24, 2013

(54) Methods of Treating a Water Sample or a Substrate to Remove Organic Compounds

(71) Applicants: John Ferry, Columbia, SC (US); Justina Burns, Columbia, SC (US); Tim Shaw, Columbia, SC (US); Preston S. Craig, Louisville, CO (US)

(72) Inventors: John Ferry, Columbia, SC (US); Justina Burns, Columbia, SC (US); Tim Shaw, Columbia, SC (US); Preston S. Craig, Louisville, CO (US)

(73) Assignee: UNIVERSITY OF SOUTH CAROLINA, Columbia, SC (US)

(21) Appl. No.: 13/470,732

(22) Filed: May 14, 2012

Related U.S. Application Data
(60) Provisional application No. 61/485,771, filed on May 13, 2011.

(51) Int. Cl. A23L 1/015; C02F 1/74; A23L 1/212

(52) U.S. Cl. 426/286; 210/758

(57) ABSTRACT

Methods for treating fruits and/or vegetables to oxide any organic contaminates thereon are provided, using an aqueous solution. The aqueous solution can include a ferrous salt and an acid, and can be exposed to oxygen gas, allowing the organic contaminates to be oxidized via exposure to the aqueous solution and oxygen gas. Then, the outer surface of the fruits and/or vegetables can be washed to remove the aqueous solution. The aqueous solution can have a pH of about 4 to about 9, and can also be adjusted during the method. Methods are also disclosed for oxidizing organic compounds in an aqueous sample via measuring the pH of the aqueous sample; determining an appropriate chemical equation for oxidation based upon the pH measured; and thereafter, adjusting the pH of the aqueous sample.

### PRIORITY INFORMATION

The present application claims priority to U.S. Provisional Patent Application Ser. No. 61/485,771 titled “Methods of Predicting Water Chemistry” of Ferry, et al. filed on May 13, 2011, the disclosure of which is incorporated by reference herein.

### GOVERNMENT SUPPORT CLAUSE

This invention was made with government support under Grant No. OCE 0752473 awarded by U. S. National Science Foundation. The government has certain rights in the invention.

### BACKGROUND

Both State and Federal governments have issued regulations governing hazardous organic and inorganic contaminants in the environment. Subsurface soil and groundwater contamination with organic contaminants has been the concern of State and Federal government since the 1970's. Action levels and clean-up standards have been promulgated by both State and Federal government for numerous organic contaminants. Regulated organic contaminants in the subsurface environment include, but are not limited to: polychlorinated biphenyls (PCBs); chlorinated volatile organic compounds (CVOCs) such as tetrachloroethene (PCE), trichloroethene (TCE), trichloroethane (TCA), dichloroethene (DCE), vinyl chloride; fuel constituents such as benzene, ethylbenzene, toluene, xylene, methyl tert butyl ether (MTBE), tertiary butyl alcohol (TBA), polynuclear aromatic hydrocarbons (PAHs), ethylene dibromide (EDB); pesticides such as (but not limited to) DDT; herbicides such as (but not limited to) silvex. Other organic materials can also be present in such waters.

Additionally, foods produced in the US and abroad can have a variety of organic contaminants (e.g., pesticides and/or herbicides) on their surface that are not removed by washing with water alone. For example, fruits and vegetables can have a variety of organic contaminants (e.g., pesticides and/or herbicides) on their outer surface, especially those fruits and vegetables with waxy skin (e.g., apples, pears, cucumbers, tomatoes, grapes, peppers, etc.), rind skin (e.g., bananas, oranges, limes, lemons, tangerines, grapefruits, etc.), or peel skin (e.g., onions, etc.).

Removing such organic contaminates from groundwaters and food products presents difficult challenges. For example, the removal of organic contaminates from groundwater has been attempted via various methods. Phase transfer technologies have been used, such as activated carbon filtration and forced air stripping. However, these techniques have environmental drawbacks in that activated carbon filtration produces toxic waste (i.e., the activated carbon filter with the adsorbed organic contaminates) and forced air stripping contributes volatile organic materials into the atmosphere.

Recently, transformative technologies have been investigated. Such technologies have a goal of changing the chemical nature of the organic contaminates to water, carbon dioxide (and/or bicarbonate derivatives), mineral acids. Thus, these technologies attempt to break down the organic contaminates to simple, nontoxic compounds. Many of these technologies attempt to rely on oxidation processes, utilizing reactive free radical species (e.g., HO.). However, the conditions required by the technologies for producing and running such reactions are not conducive to a vastly applicable solution for removing organic contaminates from a sample of water and/or a surface.

As such, a need exists for a controllable, broadly applicable transformative technology that can remove organic contaminates from samples of water and/or surface.

### SUMMARY

Objects and advantages of the invention will be set forth in part in the following description, or may be obvious from the description, or may be learned through practice of the invention.

In one embodiment, methods are generally provided for treating fruits and/or vegetables to oxide any organic contaminates thereon. For example, an aqueous solution can be applied onto an outer surface of the fruits and/or vegetables (e.g., via spraying, dipping, tumbling, etc.). The aqueous solution can include a ferrous salt and an acid. The aqueous solution can be exposed to oxygen gas, allowing the organic contaminates to be oxidized via exposure to the aqueous solution and oxygen gas. Finally, the outer surface of the fruits and/or vegetables can be washed to remove the aqueous solution.

In one embodiment, the aqueous solution can have a pH of about 4 to about 9 (e.g., about 4 to about 6.5). The method can also include adjusting the pH of the aqueous solution.

The acid included in the aqueous solution can be, in one embodiment, a weak acid that is compatible with food stuffs, including but not limited to a carboxylic acid, an alcohol, an amino acid, a phosphoric acid, a carbonic acid, or mixtures thereof. For example, suitable carboxylic acids can include, but are not limited to, citric acid, acetic acid, formic acid, lactic acid, tartaric acid, ascorbic acid, oxalic acid, or mixtures thereof. Suitable alcohols can include, but are not limited to, ethanol, propanol, isopropanol, or mixtures thereof.

The ferrous salt included in the aqueous solution can be, in one embodiment, iron(II) chloride, iron(II) bromide, iron(II) oxide, iron(II) sulfate or its derivatives, hydrates thereof, or mixtures thereof. In particular embodiments, the ferrous salt can be present in the aqueous solution in a concentration of about 50 μM to about 1 mM (e.g., 50 μM to about 0.1 mM).

The presently disclosed methods are particularly suitable for those fruits and/or vegetables that define a waxy skin, a rind skin, or a peel skin as its outer surface.

Methods are also generally disclosed for oxidizing organic compounds in an aqueous sample. In one embodiment, the method can include measuring the pH of the aqueous sample; determining an appropriate chemical equation for oxidation based upon the pH measured; and thereafter, adjusting the pH of the aqueous sample.

Other features and: aspects of the present invention are discussed in greater detail below.

### BRIEF DESCRIPTION OF THE DRAWINGS

A full and enabling disclosure of the present invention, including the best mode thereof to one skilled in the art, is set forth more particularly in the remainder of the specification, which includes reference to the accompanying figures, in which:

FIG. 1 shows that Fe(II) rapidly oxidized in O₂-saturated solutions (conditions: 18 μM Fe(II), 621.48 mM Cr, 209.08 μM Br⁻, 0.12 μM I⁻, 0.87 mM total CO₃²⁻, and 3.19 mg of C/L for SRDOM);

FIG. 2 shows DCTCB degradation was halted by the additiona of 12 mM benzoic acid, an OH scavenger (conditions: 1 μM DCTB, 18 μM Fe(II), 388.00 mM Cl⁻, 525.00 μM Br⁻, 0.30 μM I⁻, 1.73 mM total CO₃²⁻, and 8.00 mg of C/L for SRDOM);

FIG. 3 shows DCTCB continued to degrade after Fe(II) fell below detection limits (conditions: 1 μM DCTB, 18 μM Fe(II), 388.00 mM Cl⁻, 525.00 μM Br⁻, 0.30 μM I⁻, 1.73 mM total CO₃²⁻, and 8.00 mg of C/L for SRDOM);

FIG. 4 shows that the addition of 12 mM total phosphate increased the apparent rate of Fe(II) oxidation at pH 8.00 (n=6) (nominal [Cl⁻]_{O}=388 mM, [Br⁻]_{O}=525 μM, total [CO₃²⁻]_{O}=1.73 mM, SRNOM=8.00 mg C/L, [Fe(II)]_{O}=110 μM);

FIG. 5 shows that Fe(II) oxidation was accelerated by an excess of PO₄³⁻ at pH 8.0 (nominal [Cl⁻]_{O}=388 mM, [Br⁻]_{O}=525 μM, total [CO₃²⁻]_{O}=1.73 mM, SRNOM=8.00 mg C/L, [Fe(II)]_{O}=110 μM, n=3);

FIG. 6 shows that the oxidation state of Fe can cycle rapidly between Fe(II) and Fe(III) during the relatively slow net Fe(II) oxidation (L=ligand forming a water soluble Fe complex, P=precipitating ligand forming an insoluble Fe complex);

FIG. 7 shows Ln([DCTCB)]/[DCTCB]_{O}) vs. time in the presence and absence of PO₄³⁻ (12 mM) at pH 8.0 (n=3) (nominal [Cl⁻]_{O}=388 mM, [Br⁻]_{O}=525 μM, total [CO₃²⁻]_{O}=1.73 mM, SRNOM=8.00 mg C/L, [Fe(II)]_{O}=110 μM, [DCTCB]_{O}=1.00 μM);

FIG. 8 shows the location of the natural water sampling sites: 1) Lake Murray, 2) Barney Jordan Landing, 3) Bates Bridge Landing, 4) Low Falls Landing, 5) Wilsons

Landing, 6) Lenuds Landing, 7) Pleasant Hill Landing, 8) Pleasant Hill Landing, cypress swamp, 9) Pole Yard Landing, and 10) McClellanville, S.C.;

FIG. 9 shows Fe(II) oxidation was first order under all conditions: M1 conditions: pH 7.5 (n=3) (nominal [Cl⁻]_{O}=388 mM, [Br⁻]_{O}=0 μM, [CO₃²⁻]_{O}=1.73 mM, SRNOM=8.00 mg C/L, [Fe(II)]_{O}=110 μM); M2 conditions: pH 7.5 (n=3) (nominal [Cl⁻]_{O}=390 mM, [Br⁻]_{O}=0.00 μM, [CO₃²⁻]_{O}=1.90 mM, SRNOM=8.00 mg C/L, [PO₄^{3-]}_{O}=10.0 mM, [Fe(II)]_{O}=110 μM); and Low Falls Landing conditions: pH 7.30 (n=3), [Cl⁻]=1.38 mM, [CO₃²⁻]_{O}=1.47 mM, [PO₄³⁻]_{O}=0.01 mM, TOC=16.0 mg C/L, [Fe(II)]=65 μM; and

FIG. 10 shows uncoded 13 values for total CO₃²⁻ were plotted to determine their relationship to pH.

### DETAILED DESCRIPTION

Reference now will be made to the embodiments of the invention, one or more examples of which are set forth below. Each example is provided by way of an explanation of the invention, not as a limitation of the invention. In fact, it will be apparent to those skilled in the art that various modifications and variations can be made in the invention without departing from the scope or spirit of the invention. For instance, features illustrated or described as one embodiment can be used on another embodiment to yield still a further embodiment. Thus, it is intended that the present invention cover such modifications and variations as come within the scope of the appended claims and their equivalents. It is to be understood by one of ordinary skill in the art that the present discussion is a description of exemplary embodiments only, and is not intended as limiting the broader aspects of the present invention, which broader aspects are embodied exemplary constructions.

Generally speaking, the present disclosure is directed to methods for oxidizing organic compounds in an aqueous sample. The method can address the numerous variables present in typical samples (e.g., taken from natural bodies of water) so as to be applicable across a wide range of water samples. In particular, the method harnesses the natural reaction of Fe(II) to Fe(III) when oxygen is in excess to produce a suite of radical species.

I. Experimental Designs

One of the advantages of multifactorial experimentation in environmental chemistry is that it defines environmental relevance as a series of ranges rather than a collection of discrete points, i.e., a condition describing a particular geographical or temporal locale. This is particularly useful when describing complex, multistep systems that can function in multiple environmental compartments, such as the activation of dioxygen by Fe [Fe(II) complexes or Fe(0)]. An example of this is the Fe-mediated reduction of O₂ to generate H₂O₂, resulting in a Fenton-like series of reactions that generate reactive oxygen species, including superoxide and the HO. radical. This process has been explored for its potential utility as an environmental remediation technology but is also likely to occur naturally in the environment wherever Fe rich waters are exposed to dioxygen (the margins of subterranean estuaries, overturning lakes, hydrothermal vents, irradiated atmospheric waters, etc.). Fe-driven oxygen activation may be particularly important as a source of reactants for transforming dissolved organics.

The concentration of Fe(II) in shallow coastal groundwater is often in excess of 100 μM and has been reported to be as high as 17 mM. Hydraulic gradients and tidal pumping drive the transport of these waters into permeable sediments, supporting exchange with oxygen-bearing overlaying waters at a rate of 20-40 kg/m² per day on the Southeastern coast of the United States. The Fe(II)/Fe(III) couple equilibrates during transport as a function of local conditions (O₂, pH, total CO₃²⁻, halides, etc.), progressing toward net conversion of Fe(II) to Fe(III) when oxygen is in excess, with the concurrent production of a suite of radical species (eqs 1-10).

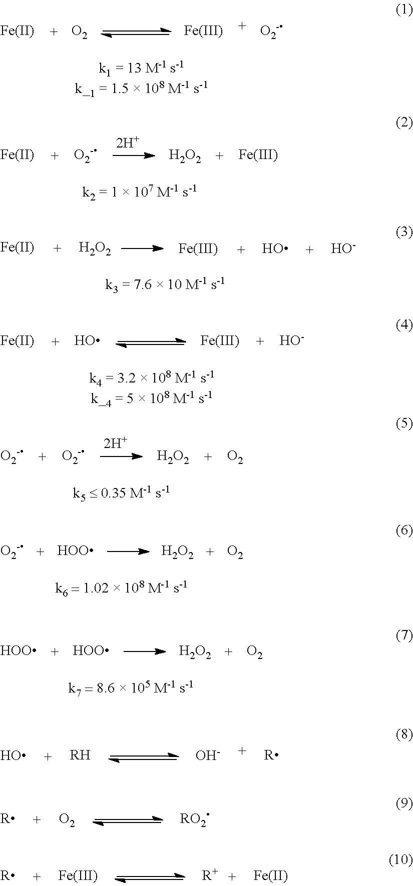

Fe(II) oxidation kinetics in surface waters are a complex function of the concentration of several dissolved species that vary geographically and temporally across watersheds.

“Hard” predictive models of chemical reactions are based on a thorough knowledge of the relevant physico-chemical descriptors of the studied system, such as stability constants, molecular speciation and rate constants. The de facto dependence on description preceding prediction limits the applicability of this strategy to well defined systems where speciation is essentially constant and known. However, a given water parcel can experience events that rapidly move solution conditions outside narrowly defined initial sets. Examples include mixing during tidal exchange; mixture of two water bodies in precipitation events, efflux of anoxic pore waters to oxic overlying waters, etc. In contrast, empirical combinatorial process models are based on the analysis of data generated by a large number of model systems with compositions that encompass a wide range of analogous (or actual) initial conditions, including those encountered during rapid mixing events. Typically, these descriptive models are generated by multivariate analysis of the results of a large number of model experiments. They do not require exhaustive knowledge of initial environmental molecular conditions prior to prediction or the fundamental equilibrium and kinetic constants used to describe chemical reactions.

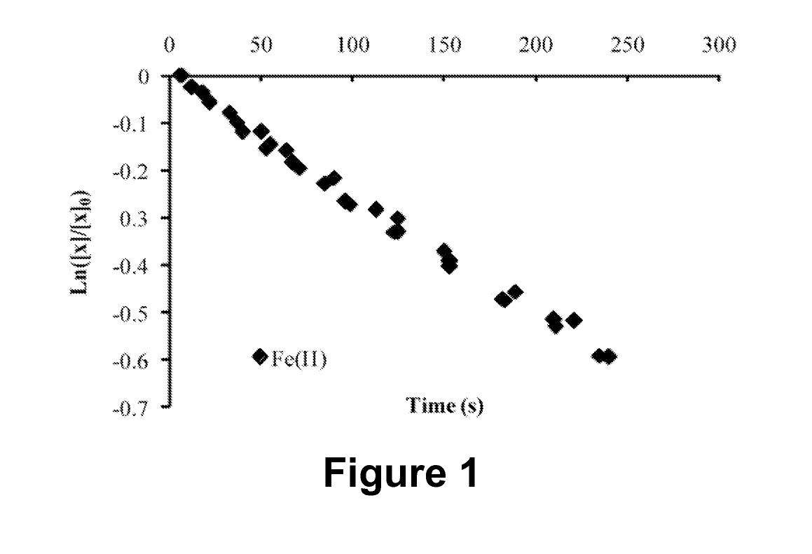

The net oxidation of Fe(II) in natural waters is affected by several dissolved species that vary (and co-vary) over small geographical and temporal scales, including those that promote oxidation, reduction, and precipitation (FIG. 1). This has generally precluded the successful prediction of Fe(II) oxidation rates across complex water bodies where these species vary by more than a relative few percent (“success” defined as agreement at the 95% confidence level between the observed net Fe(II) oxidation rate in field samples and predicted rate). As such, a need exists for methods of predicting the Fe(II) oxidation rates across a body of water.

The present inventors have found, in particular, two combinatorial experimental designs can account for the effects of independent and co-varying factors on net Fe(II) oxidation.

Design M1 examined the relationship between the net rate of Fe(II) oxidation and pH, Cl⁻, Br⁻, Fe(II), CO₃²⁻ (representing total carbonate species for the discussion), and Suwanee River natural organic matter isolate (SRNOM). All species were chosen based on their previously documented effects on the Fe(II) oxidation system. M1 featured unrestricted opportunities for Fe(II)/Fe(III) cycling; i.e. no precipitating agents were deliberately added.

Design M2 incorporated a precipitating agent (PO₄³⁻, representing total phosphate species for the discussion) to restrict cycling by encouraging Fe(III) precipitation, as well as pH, Cl⁻, Br⁻, Fe(II), CO₃²⁻ and SRNOM.

M1 and M2 were five and six factor Box-Wilson designs respectively, with each factor except pH varied across five concentration levels varying across a range that corresponded to fresh water to approximately 40 parts per thousand salinity. The problem of co-variation within the Box Wilson design was avoided by incorporating pH as a stacking index rather than an independent factor; i.e. several experimental designs incorporating the other factors were repeated at different pHs (pH 6.5-8.5 in 0.5 increments). Statistically significant factors were identified and the magnitude of their effects across the pH range determined, to yield a reduced model describing Fe(II) oxidation in both scenarios (i.e. unrestricted cycling or restricted cycling, precipitation induced).

In one embodiment, the method can include measuring the pH, the concentration of Cl⁻, the concentration of Fe(II), the concentration of CO₃²⁻, and/or the concentration of PO₄³⁻ in the aqueous sample. Other variables may also be measured. Then, an equation can be selected from equations 18 or 19 (below), using the determined amounts of these variables.

log k_{M1,P}=(−0.2901 pH²+4.5364 pH−20.38)+(0.0003 pH²−0.0045 pH+0.0164)[Cl⁻]_{O}+(−0.0004 pH²+0.0047 pH−0.0181)[Fe(II)]_{O}+(0.09 pH²−1.2393 pH²−1.2392 pH+4.5902)[CO₃⁻²]_{O} (18)

log k_{M2,P}=(−0.6244 pH²+10.263 pH−43.495)+(0.001 pH−0.0083)[Cl⁻]_{O}+(0.0023 pH³−0.0523 pH²+0.3873 pH−0.9468)[Fe(II)]_{O}+(−0.0235 pH²+0.2958 pH+0.8375)[CO₃⁻²]_{O}+(0.0154 pH³+0.3514 pH²−2.6605 pH+6.7165)[PO₄^{3-]}_{O} (19)

The variables can then be adjusted as desired (e.g., adjusting the pH) to bring the components to the reactive levels, and the reaction can begin. When oxygen is present, the reaction can self-start once the components are adjusted to the reactive levels. Alternatively, exposing to oxygen can start the reaction.

II. Treating a Sample of Water

In order to harness the ability of Fe(II) to form radical species, and in particular the HO. radical, which can oxidize the targeted organic contaminates in the sample into water, carbon dioxide and/or carbonates, and mineral acids.

According to the method, Fe(II) salts or their corresponding hydrates can be added to a sample of water. In one embodiment, the Fe(II) is added in the form of a ferrous salt, including but not limited to iron(II) chloride (i.e., ferrous chloride: FeCl₂), iron(II) bromide (i.e., ferrous bromide: FeBr₂), iron(II) oxide (i.e., ferrous oxide: FeO), iron(II) sulfate (i.e., ferrous sulfate: FeSO₄) and/or its derivatives (e.g., ammonium iron(II) sulfate: (NH₄)₂Fe(SO₄)₂.6H₂O), hydrates thereof, or mixtures thereof.

Prior to or after adding the desired amount of iron(II) is in the sample, the pH of the sample can be measured and subsequently adjusted. For example, the appropriate chemical equation for oxidation based upon the measured pH of the sample can indicate the adjustment required, according to the equation number 18 or 19 discussed above. Other variables may also be measured and adjusted, such as the concentration of C⁻ in the aqueous sample, the concentration of Fe(II) in the aqueous sample, the concentration of CO₃²⁻ in the aqueous sample, and/or the concentration of PO₄³⁻ in the aqueous sample. Once adjusted to the desired parameters, for example as calculated according to the equation number 18 or 19 discussed above, the oxidation reaction can begin in the presence of oxygen. In one particular embodiment, oxygen can be added to the sample, or the sample can be exposed to oxygen (e.g., within the atmosphere).

Although this reaction is relatively slow, the organic contaminants can be sufficiently oxidized over time into water, carbon dioxide and/or carbonates, and mineral acids.

III. Treating Fruits and Vegetables

In one particular embodiment, a method is generally provided for removing organic contaminates from the outer surfaces of fruits and vegetables. Specifically, iron(II) can be utilized to oxidize the organic contaminates on their surface into water, carbon dioxide and/or carbonates, and mineral acids.

The methods described herein are particularly suitable for removing organic contaminates (e.g., pesticides and/or herbicides) from the outer surfaces of those fruits and vegetables with waxy skin (e.g., apples, pears, cucumbers, tomatoes, grapes, peppers, etc.), rind skin (e.g., bananas, oranges, limes, lemons, tangerines, grapefruits, etc.), or peel skin (e.g., onions, etc.). Since iron is not soluble in wax, the iron does not penetrate such skins of the fruits and vegetables in any significant amount, and can be readily washed from their surfaces (e.g., with water) upon completion of the transformative cleaning.

An aqueous solution containing iron(II) in the form of a ferrous salt can be applied to the fruits and/or vegetables. For example, the aqueous solution can be sprayed onto the fruits and/or vegetables. Alternatively, the fruits and/or vegetables can be dipped into a bath of the aqueous solution. In one particular embodiment, the fruits and/or vegetables can be tumbled within a bath of the aqueous solution in a manner that allows the aqueous solution and the fruits and/or vegetables to constantly intermix with air (i.e., oxygen).

The aqueous solution can also contain an acid or combination of acids. In one embodiment, the acid can be a weak acid that is compatible with food stuffs, including but not limited to carboxylic acids (e.g., citric acid, acetic acid, formic acid, lactic acid, tartaric acid, ascorbic acid, oxalic acid, etc.), alcohols (e.g., ethanol, propanol), amino acids, phosphoric acids, carbonic acid, etc., or mixtures thereof. In general, the pH of the aqueous solution can be about 4 to about 9 (e.g., about 4 to about 6.5).

In one embodiment, the ferrous salt included in an aqueous solution in a relatively dilute concentration, such as about 50 μM to about 1 mM (e.g., 50 μM to about 0.1 mM).

Once applied onto the surface of the fruits and/or vegetables and the reactive conditions suitably adjusted (e.g., see equations 18 and 19), the aqueous solution can be mixed with oxygen (e.g., in the atmosphere) to begin the oxidation reaction.

### EXAMPLES

The validity of this approach was tested by using the simplified models to predict Fe(II) oxidation rates at 10 different locations in the Congaree-Santee rivers. The sampling locations corresponded to widely differing land use patterns, including a drinking water reservoir, urban boat landing, cypress swamp and intracoastal waterway.

A series of experiments were performed that led to the development of a combinatorially based predictive model for hydroxyl radical generation during the oxidation of aqueous Fe(II) solutions. This new Advanced Oxidation Process was optimized using the predictive model and tested by evaluating the oxidation of two different pesticides that are commonly found micropollutants, dichlorothalonil and fipronil. The terminal electron acceptor for the process was atmospherically derived dioxygen. Hydrogen peroxide was generated in-situ during Fe(II) oxidation and its subsequent reaction with Fe(II) resulted in HO. generation. The system was optimized for HO. production using the predictive models described in the Examples below and corresponding supplemental sections.

### Example 1

The generation of HO. is reported under a wide range of conditions during net Fe(II) oxidation, as determined by the oxidation of the organic probe molecules 1,3-dicyanotetrachlorobenzene (DCTCB) and fluocyanobenpyrazole (FCBP). Corresponding Fe(II) oxidation rates and Fe(II)/Fe(III) cycling were correlated to “local” solution conditions through the application of a multifactorial experimental design. Our approach for measuring Fe(II)/Fe(III) cycling and probe oxidation was to employ a five factor, five-level central composite experimental design to interrogate a parameter space incorporating independently varying nominal concentrations of factors Cl⁻, Br⁻, I⁻, and CO₃²⁻ (representing total carbonate species) and the concentration of SRNOM. All of these factors are significant during Fe(II) oxidation and/or are also potential scavengers for secondary oxidants such as HO.. Factor ranges encompassed the saline and fresh water end members as well as the intermediate conditions encountered during the mixing of the same in permeable sediments and estuaries.

The correlation between the rate of Fe(II) oxidation, the rate of DCTB oxidation, the ratio of rates of DCTCB oxidation to FBCP oxidation, and the various factors (acting independently and cooperatively) was measured. The absolute quantification of the effects of each factor or factor-factor interaction was also obtained. The center point of the experimental design was repeated in the presence of scavengers for selected secondary oxidants, including superoxide dismutase (for removing O₂^{-•}) or benzoic acid (for removing HO;). The yield of HO. as a function of Fe(II) consumed was estimated under all conditions.

Materials: Salts and acids were acquired from Fisher Scientific and used as received. FerroZine (98%) was acquired from VWR. Superoxide dismutase (5030 units/mg of protein) was acquired from Aldrich. SRNOM was acquired from the International Humic Substances Society (Tables 1-4 of the Supporting Information). Fluocyanobenpyrazole (FCBP or fipronil) was from O-Chem and 1,3-dicyanotetrachlorobenzene (DCTCB or chlorothalonil) from TCI America. All reagents were used as received. All solutions were made in Barnstead E-pure (18 MΩcm-1) water.

Experimental Design. The effects of the five factors [Cl⁻, Br⁻, I⁻, (CO₃²⁻)ₜₒₜ, and SRNOM] and their interactions were determined using a circumscribed Box-Wilson experimental design (Table 1), with factor concentrations bracketing ranges found in the freshwater-saltwater mixing zone. The design required six replicate experiments at the center point and three replicate experiments under all other conditions. The overall matrix was a series of 43 different experimental conditions in the defined parameter space as determined by the design algorithm (conditions and results detailed in Table 1 and Tables 5-9 of the Supporting Information). The sequence of experiments was randomized to eliminate time dependent artifacts. All experiments were conducted at a pH of 8.00 (0.10 and 20° C. to minimize effects of varying SRNOM and carbonate speciation and reduce the effects of the changing activity of hydroxide. pH measurements were taken using an Orion 410A pH meter with a Cole-Parmer combination electrode calibrated with NIST buffers at relevant ionic strengths for different conditions in the experimental design (FIGS. 1-3 of the Supporting Information). The nominal “zero” level for each factor was set at the condition corresponding to 18 MΩ deionized filtered water (TOC<50 ppb). High levels for each factor were set at 120% of their approximate open seawater concentration, enabling the experimental matrix to bracket a significant fraction of terrestrial surface waters.

TABLE 1
Design Points for the Five-Factor Central
Composite Design Used in All Experiments

| factor (units) | factor concentration level^{a} | | | | |
|---|---|---|---|---|---|
| coded factor level | −2 | −1 | 0 | 1 | 2 |
| factor x₁, (Cl⁻] (mM) | 0.00 | 154.52 | 388.00\| | 621.48 | 776.00 |
| factor x₂, [Br⁻] (μM) | 0.00 | 209.08 | 525.00 | 840.92 | 1050.00 |
| factor x₃, [I⁻] (μM) | 0.00 | 0.12 | 0.30 | 0.48 | 0.60 |
| factor x₄, total | 0.30 | 0.87 | 1.73 | 2.58 | 3.15 |
| [CO₃²⁻] (mM) | | | | | |
| factor x₅, SRNOM | 0.00 | 3.19 | 8.00 | 12.81 | 16.00 |
| (mg of C/L) | | | | | |

^{a}Denotes initial concentrations.

Iron(II) Oxidation. Fe(II) oxidation was followed using previously published methods (See, Craig, P. S.; Shaw, T. J.; Miller, P. L.; Pellechia, P. J.; Ferry, J. L. Use of multiparametric techniques to quantify the effects of naturally occurring ligands on the kinetics of Fe(II) oxidation. Environ. Sci. Technol. 2009, 43 (2), 337-342 and Stookey, L. L. Ferrozine: A new spectrophotometric reagent for iron. Anal. Chem. 1970, 42 (7), 779-781.).

HO. Quantification. Experiments involving the HO. probes DCTCB and FCBP were conducted in the same manner described above. The probe molecule was spiked at a constant initial concentration of 1 μM for all experiments from saturated aqueous stock solutions. Samples were withdrawn as a function of time, and the reaction was quenched by addition to a FerroZine solution. All samples were handled in the dark, immediately extracted with methyl tert-butyl ether, and then analyzed using gas chromatographic techniques.

Scavenger Experiments. Midpoint condition solutions were used to assay mechanisms for (1) Fe(II) oxidation and (2) probe molecule degradation. Scavengers for O₂^{-•} (50000 units/L of superoxide dismutase) and HO. (12 mM benzoic acid) were added to remove the specific transient oxidant. The effect of added benzoate on the overall Fe speciation is minimal under our experimental conditions (3, 4) (Table 10 of the Supporting Information).

### Results

Fe(II) Oxidation. Fe(II) rapidly oxidized and was first order with respect to Fe(II) (FIG. 1), under the range of conditions explored in the experimental design (Table 1). The method of initial rates [kobs obtained at the first Fe(II) half-life, average r²)0.98 for 396 experiments] was used to determine the kobs for Fe(II) oxidation (Table 5 of the Supporting Information). The rate of Fe(II) oxidation did not correlate with ionic strength or the activity of the hydroxide ion under our experimental conditions [r² for either relationship<0.02], an observation consistent with previous results. The relationship between the five parameters and log (kobs) was evaluated by fitting a full quadratic expression to the response surface (eq 11). The response surface correlated to the observed outcomes with an r² value of 0.93.

log(k_{obs})=β₀+β₁x₁+β₂x₂+β₃x₃+β₄x₄+β₅x₅+β₁₁x₁²+β₂₂x₂²+β₃₃x₃²+β₄₄x₄²+β₅₅x₅²+β₁₂x₁x₂+β13x₁x₃+β₁₄x₁x₄+β₁₅x₁x₅+β₂₃x₂x₃+β₂₄x₂x₄+β₂₅x₂x₅+β₃₄x₃x₄+β₃₅x₃x₅+β₄₅x₄x₅ (11)

Evaluation of the contributions of each term indicated that total [CO₃²⁻], SRNOM, [Cl⁻]², and [Br⁻]² all contributed positively (+) to the net rate of Fe(II) oxidation at the 95% confidence level [p e 0.05 (Table 2)]. The factors [Cl⁻], [CO₃²⁻]², and CO₃²⁻-SRNOM acted to reduce (−) the rate of Fe(II) oxidation. The sum of squares for each factor over the sum or squares for the model (SS_x/SSM) indicated the magnitude of the effect of each factor in the system (Table 2).

TABLE 2
Parameter Estimates and Hypothesis Tests for the Parameters
of the Quadratic Model Fitted to the Log Transformed Data for
Fe(II) Oxidation in the Absence of Probe Molecules^{a}

| | | coefficient | standard | | | |
|---|---|---|---|---|---|---|
| | | estimate | error | F | p value | % |
| parameter | βₓ key | (×10⁻²) | (×10⁻²) | value | (p > F) | contribution |
| β₀ | intercept | −201.66 | 4.07 | | | |
| β₁ | [Cl⁻] | −10.57 | 1.30 | 66.10 | <0.0001^{b} | 4.44 |
| β₂ | [Br⁻] | −2.25 | 1.30 | 2.99 | 0.0866 | 0.20 |
| β₃ | [I⁻] | 1.27 | 1.30 | 0.96 | 0.3305 | 0.06 |
| β₄ | [CO₃²⁻]ₜₒₜ | 45.78 | 1.30 | 124.00 | <0.0001^{b} | 83.19 |
| β₅ | SRNOM | 13.19 | 1.30 | 10.30 | <0.0001^{b} | 6.91 |
| β₁₂ | [Cl⁻]—[Br⁻] | −0.10 | 1.41 | 0.001 | 0.9430 | 0.00 |
| β₁₃ | [Cl⁻]—[I⁻] | −1.52 | 1.41 | 1.16 | 0.2829 | 0.08 |
| β₁₄ | [Cl⁻]—[CO₃²⁻]ₜₒₜ | −1.77 | 1.41 | 1.59 | 0.2102 | 0.11 |
| β₁₅ | [Cl⁻] - SRNOM | 0.37 | 1.41 | 0.07 | 0.7933 | 0.00 |
| β₂₃ | [Br⁻]—[I⁻] | −1.24 | 1.41 | 0.78 | 0.3801 | 0.05 |
| β₂₄ | [Br⁻]—[CO₃²⁻]ₜₒₜ | −1.97 | 1.41 | 1.96 | 0.1643 | 0.13 |
| β₂₅ | [Br⁻] - SRNOM | 0.14 | 1.41 | 0.01 | 0.9195 | 0.00 |
| β₃₄ | [I⁻]—[CO₃²⁻]ₜₒₜ | 0.96 | 1.41 | 0.46 | 0.4972 | 0.03 |
| β₃₅ | [I⁻] - SRNOM | −2.59 | 1.41 | 3.39 | 0.0683 | 0.23 |
| β₄₅ | [CO₃²⁻]ₜₒₜ - SRNOM | −7.67 | 1.41 | 29.70 | <0.0001^{b} | 1.99 |
| β₁₁ | [Cl⁻]² | 5.47 | 2.04 | 7.19 | 0.0084^{b} | 0.48 |
| β₂₂ | [Br⁻]² | 4.85 | 2.04 | 5.66 | 0.0190^{b} | 0.38 |
| β₃₃ | [I⁻]² | 1.29 | 2.04 | 0.40 | 0.5279 | 0.03 |
| β₄₄ | [CO₃²⁻]ₜₒₜ² | −10.01 | 2.04 | 24.10 | <0.0001^{b} | 1.62 |
| β₅₅ | SRNOM² | −2.06 | 2.04 | 1.02 | 0.3150 | 0.07 |

^{a}This is for the coded factor levels from Table 1.
^{b}Tests as significant at the 95% confidence level.

Using this analysis, the major factors (>5% of the outcome) are [CO₃²⁻] and SRNOM, which combined account for about 90% of the response surface for this range of conditions (Table 1) and are also consistent with a system containing variable Cl⁻, SO₄²⁻, F⁻, NOM, and CO₃²⁻ levels. The effects of secondary oxidants produced during

Fe(II) oxidation on k_{obs} were determined by the addition of individual, selective scavengers to a series of replicate experiments performed at the midpoint condition (Table 3).

TABLE 3
Resulting k_{obs} Values for the Scavenger Experiments

| | species | k_{obs}(Fe(II)) | k_{obs}(DCTCB) | k_{obs}(FCBP) |
|---|---|---|---|---|
| scavenger | removed | (×10⁻³ s⁻¹) | (×10⁻³ s⁻¹) | (×10⁻³ s⁻¹) |
| none | — | 7.63 ± 1.23 | 1.88 ± 0.52 | 1.42 ± 0.41 |
| superoxide | O₂^{-•} | 3.67 ± 0.25 | 0.27 ± 0.06 | 0.83 ± 0.23 |
| dismutase | | | | |
| (50000 units/L) | | | | |
| benzoic acid | HO• | 3.20 ± 0.62 | no reaction | no reaction |
| (12 mM) | | | | |

The system was sensitive (99.5% confidence interval) to the removal of either superoxide (scavenged by superoxide dismutase) or HO. (scavenged by benzoic acid) under these conditions, with an approximate 50% reduction in rate upon the addition of an excess of either, a result unique to this study. Although these experiments indicated that the effects of secondary oxidants could be of nearly the same level as the effects of O2, there are caveats: the action of either scavenger could lead to the formation of hydrogen peroxide, which could go on to participate in net Fe(II) oxidation through the Fenton reaction.

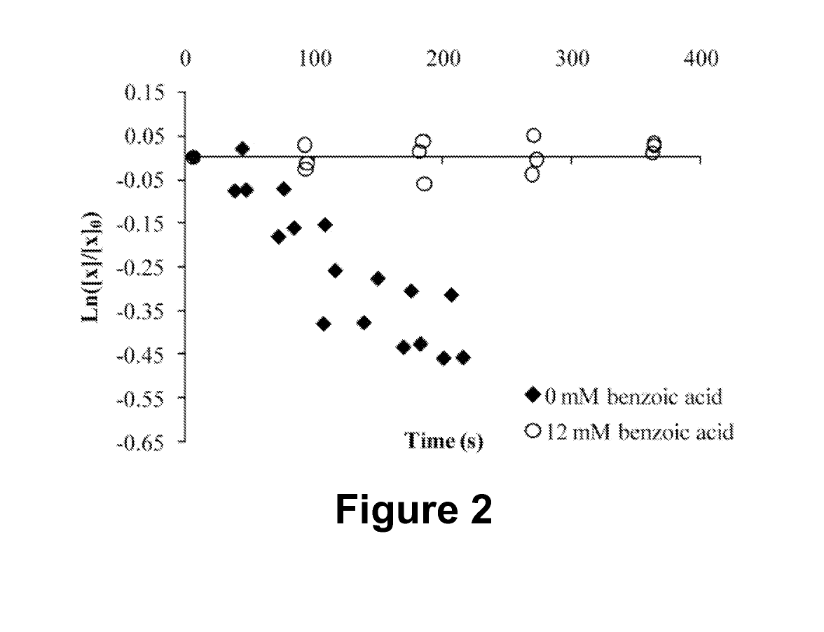

HO. Quantification. The experiments defined in Table 1 were repeated with the addition of either DCTCB or FCBP (the initial concentration of either probe molecule was 1 μM) as the probe molecule for measuring the yield of HO. The mechanism of probe oxidation was investigated by obtaining the rates of DCTCB and FCBP oxidation at the midpoint condition in the presence of the scavengers superoxide dismutase and benzoic acid (Table 3). The oxidation of both probes was halted in the presence of benzoic acid (DCTCB oxidation shown in FIG. 2).

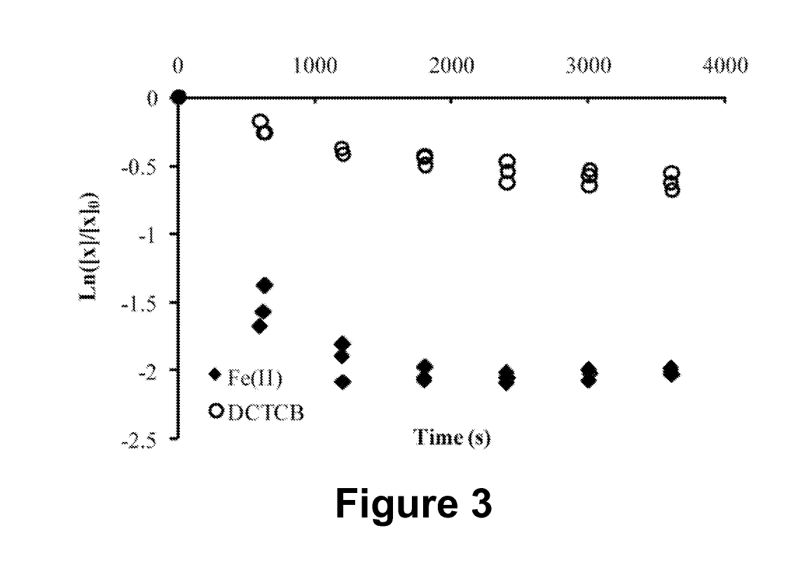

The degradation of both probes was also monitored for an extended period of time (60 min), well past the point at which the concentration of Fe(II) fell below detection limits (about 2 μM under our conditions). The oxidation continued over this time period with about 75% of the total occurring after the apparent loss of Fe(II) from the system (FIG. 3). Probe loss due to adsorption to colloidal iron oxides generated in the samples during Fe(II) oxidation was considered. Adsorption of neutral organics to metal oxides tends to be strongly dependent on ionic strength and associated natural organic matter. No correlation was observed between probe loss and these factors (FIGS. 2 and 3). The ratio of the experimental rates for the loss of the two probes is essentially constant and small [average k_{obs}(FCBP)/k_{obs}(DCTCB))1.83(1.77] over all experimental conditions. The observations are inconsistent with losses related to phase transfer given the about 1000-fold difference in probe solubilities but are consistent with loss through reaction with a single oxidant.

The rates of Fe(II) oxidation in the presence of either probe were not significantly different (at the 95% level of confidence) from those obtained in their absence. The fit describing the rate of Fe(II) oxidation as a function of the total system in the presence of the probes had an r² value of 0.97. The same parameters were significant in the presence or absence of probes (eq 11). These results indicated the probes were capable of interrogating the system without perturbing it with DCTCB scavenging ≦1% of HO..

Fe(II)/Fe(III) Cycling. DCTCB degraded only after addition of Fe(II) (FIG. 3). The relationship of In([DCTCB]t/[DCTCB]0) versus time was linear for all conditions. DCTCB loss was attributed to HO. and not reaction with other oxidants (vide infra). The yield of HO. under each experimental condition was estimated (eq 12) from the ratio of the number of moles of DCTB consumed to the efficiency of HO. scavenging by DCTCB applied from 0 to 4 min based on the known bimolecular rate constant of HO with DCTCB.

$$moles of HO \cdot produced = \frac{Δ moles of DCTCB}{fraction of HO \cdot scavanged by DCTCB} \qquad ( 12 )$$

On the basis of the calculated efficiency for each condition and assuming a 1:1 stoichiometry between HO. and the probes (Table 13 of the Supporting Information), the number of moles of HO. produced consistently exceeded the number of moles of Fe(II) oxidized, suggesting that back reactions between Fe(III) and various reductants (eqs 1-4 and 10) led to the regeneration of Fe(II) over the course of net Fe(II) oxidation. The number of Fe(II)/Fe(III) cycles the system required to generate this quantity of HO. was calculated from the ratio of the number of moles of HO. produced relative to the number of moles Fe(II) consumed [assuming a molar yield of 1 mol of HO. to 3 mol of Fe(II); eq 13 and Table 5 of the Supporting Information]:

$${( number of Fe ( II ) / Fe ( III ) cycles )}_{t} = 3 \{ \frac{{( moles of HO \cdot produced )}_{t}}{{[ net moles of Fe ( II ) consumed ]}_{t}} \} \qquad ( 13 )$$

The number of Fe(II)/Fe(III) cycles ranged from approximately 10 to 2200 times depending on solution conditions. A response surface was generated and modeled to examine the correlation between the number of cycles and the five factors (r2) 0.80, based on eq 11 and substituting the number of cycles for kobs). The values of the various coefficients and the estimates of their significance are found in Tables 33-35 of the Supporting Information. Analysis of the relative sum of squares for the factors showed the major single factors contributing to Fe cycling were [Br⁻] (61.3%) and [CO₃²⁻]² (5.6%). CO₃²⁻ (7.2%) and (Br⁻)² (9.7%) inhibited Fe cycling. All other terms contributed less than 5% to the experimental outcome.

### Discussion

Fe(II) complexes in aerated waters are oxidized by dioxygen and a suite of secondary oxidants, including superoxide, hydrogen peroxide, HO., and in the presence of NOM several possible organic radicals (eqs 1-4, 9, and 10). Secondary oxidants played an important role in the system as qualitatively indicated by the nominal removal of either superoxide (excess superoxide dismutase) or HO. (excess benzoic acid). The removal of either resulted in a net decrease in the experimental oxidation rate of Fe(II) by ˜50% (Table 3). The most significant positive contributors to Fe(II) oxidation were (in increasing order) chloride, SRNOM, and total carbonate. Chloride is unlikely to react with any of the known secondary oxidants in this system at pH>3. NOM and carbonate are both known HO. scavengers and could depress the net oxidation rate. However, at environmentally relevant concentrations with excess oxygen (this system), these factors promoted Fe(II) oxidation by acting as ligands, rather than moderators of secondary oxidant activity.

The relationship between Fe(II)/Fe(III) cycling and secondary oxidant production was investigated through the cooxidation of dissolved organic probes over a range of system factors. Probe oxidation continued long after [Fe(II)] fell below the experimental detection limit, suggesting Fe(II) regeneration during the net oxidation process with concurrent generation of secondary oxidant(s). This is consistent with known mechanisms of HO. production during the Fenton process, the Udenfriend process, and the oxidation of organics by zero-valent Fe. The ratio of the experimental rates for the loss of the two probes is essentially constant, implying their loss is from reaction with only one oxidant under all conditions. The addition of the HO. scavenger benzoic acid halted probe oxidation. This result discriminates between HO. and Fe(IV) as possible probe oxidants, based on the low rate constant for the reaction of benzoic acid and Fe(IV) versus that of benzoic acid with HO.(3). Further, the correlation between kobs for either probe and ionic strength (across all conditions) was low [r2<0.01 for both (FIGS. 2 and 3 of the Supporting Information)], which would be expected for reactions between neutral species (i.e., HO.). Cumulatively, these results do not exclude the presence of Fe(IV), but they do exclude its role as a primary oxidant of DCTCB or FCBP under our conditions. Rather, this pattern of outcomes is compatible with the known chemistry of HO.. With the oxidant established, the extent of Fe cycling was determined by the number of moles of probe consumed over a set period of time [based on the stoichiometry of HO. production and assuming a 1:1 stoichiometry between HO. and probe (eqs 1-3)] (Table 11 of the Supporting Information).

The correlative model describing Fe(II)/Fe(III) cycling indicated Br⁻ was the most significant factor promoting cycling (Table 4). Speculatively, there are several possible ways bromide could contribute to Fe cycling. If bromide acted as a HO. scavenger in the system, then DCTCB could have been oxidized directly by the resultant bromine atoms. However, under our conditions, it is more likely the bromine atoms would have been scavenged by bromide to generate Br^{2-.}. This radical is a strong oxidant but reacts relatively slowly with aromatics with electron-withdrawing substituents. It is also capable of oxidizing Fe(II) directly, which may account for the negative contribution of [Br⁻]² to cycling. It is also possible that Fe(III)-Br complexes may be readily reduced by reductants such as superoxide on the long time scale of the cycling experiments, an effect not necessarily observable on the short time scale of Fe(II) oxidation.

This study demonstrates the apparent catalytic formation of HO. under conditions where Fe(II) is introduced into systems with dissolved oxygen, a high Br⁻ concentration, and a high total CO₃²⁻ concentration, with potential cycle numbers on the order of 103. The lifetime of the catalytic cycle in these environments is likely to be limited by the eventual precipitation of insoluble Fe(III) oxides, hydroxides, and carbonates. These conditions occur naturally at locations such as river mouths, estuaries, hydrothermal vents, and coastal ground waters with continuous or pulsed Fe(II) inputs. Although the instantaneous volume of water affected by this cycle should be relatively small, the volume would be distributed over an interface through which large volumes of water pass as the compartments of the hydrosphere exchange. Speculatively, the oxidants generated during passage through these interfaces could be considered a kinetically selective membrane, affecting the transport of dissolved organics and microbes from terrestrial to marine systems.

### Example 2

The one electron oxidation of aqueous Fe(II) by dioxygen is thermodynamically favored and rapid under many environmental conditions. This reaction is the initiation step for the formation of several reactive oxygen species (ROS) and occurs wherever the discharge of anoxic groundwater introduces Fe(II) to oxygenated waters in rivers, subterranean estuaries, hydrothermal vents, etc. Reactive species generated in these environments include O₂^{-•}, HO., H₂O₂, carbon centered radicals and peroxyl radicals (FIG. 6). Some of these are capable of the one electron reduction of Fe(III) complexes, and the published data indicates that Fe may cycle many times between the Fe(II) and Fe(III) oxidation states during the net oxidation process. This means a general description of the kinetics for net Fe(II) loss needs to account for Fe(II) oxidation and feedback from concurrent Fe(III) reduction (Eqn 6):

$$- {( \frac{[ d Fe ( II ) ]}{d t} )}_{net} = \sum {k}_{ox} [ Fe ( II ) ] [ oxidants ] - \sum {k}_{red} [ Fe ( III ) ] [ reductants ] \qquad ( 16 )$$

where kₒₓ and k_{red} are the generic rate terms for the rate constants of the summed Fe(II) oxidation and Fe(III) reduction reactions respectively. The term “oxidants” includes dioxygen and various ROS and “reductants” includes superoxide and (speculatively) various carbon centered radicals. Fe cycling is ultimately limited in environmental and biological systems by the loss of Fe(III)_{aq} through precipitation as sparingly soluble complexes such as Fe₂(CO₃)₃, FePO₄, and Fe(OH)₃/oxyhydroxides.

In this study contrasting combinatorial data sets were generated that described the rate of Fe(II) oxidation in the presence or absence of added phosphate (PO₄³⁻, representing total phosphate species). The overall experimental conditions were mixtures of Cl⁻, Br⁻, Fe(II), (CO₃²⁻)ₜₒₜ and Suwannee River natural organic matter (SRNOM), collectively interrogated by experiment in the presence and absence of added phosphate. All of the factors were selected based on previously published observations that individually, the factors interacted with the net Fe(II) oxidation process and/or were also reactive with secondary oxidants such as HO.. Factor ranges were chosen to encompass the saline and fresh water end members as well as the intermediate conditions encountered during the mixing of the same in permeable sediments and estuaries. This phenomena is often observed at locations where organic rich ground waters mix with overlying oxygenated waters, including the Chesapeake Bay, the Carolina and Florida coasts, Patos Lagoon and in fluidized Amazonian muds. Phosphate was added to selectively precipitate Fe(III) from solution and thereby reduce the rate of Fe(III) reduction. Comparison of the two data sets demonstrated evidence for short term Fe cycling governed kinetically by the speciation of resulting Fe(III). Fluocyanobenpyrazole (FCBP) and 1,3-dicyanotetrachlorobenzene (DCTCB) were used as probes for the presence of HO, in accordance with a method reported previously. The effects of each factor or factor-factor interaction on the net rate of Fe(II) oxidation were quantified.

### Experimental Methods

Materials. All salts (99%+), solvents, and acids were acquired from Fisher Scientific. FerroZine® reagent (98%) was purchased from VWR. Suwannee River NOM (SRNOM) was acquired from the International Humic Substances Society (IHSS) (see Supp. Tables 1-4 for elemental composition). Fluocyanobenpyrazole (FCBP or fipronil) was from O-Chem and 1,3-dicyanotetrachlorobenzene (DCTCB or chlorothalonil) from TCI America. All reagents were used as received. All solutions were made in Barnstead E-pure (18 MΩcm⁻¹) water which had been distilled to remove residual H₂O₂.

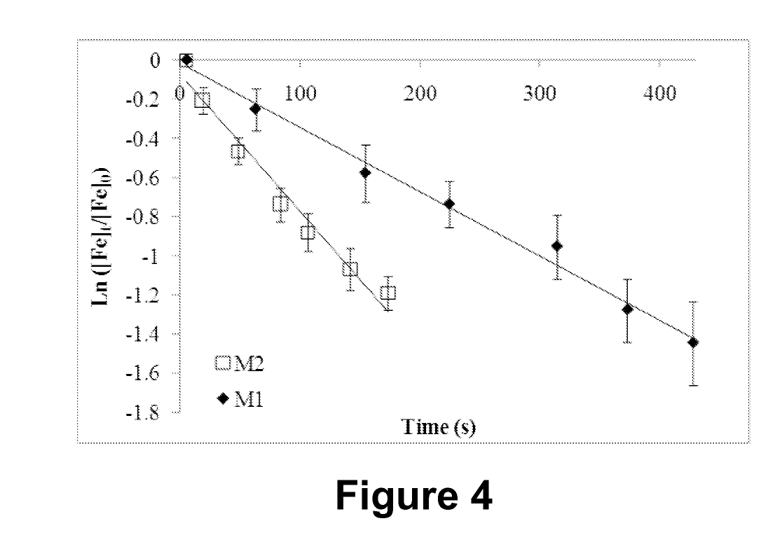

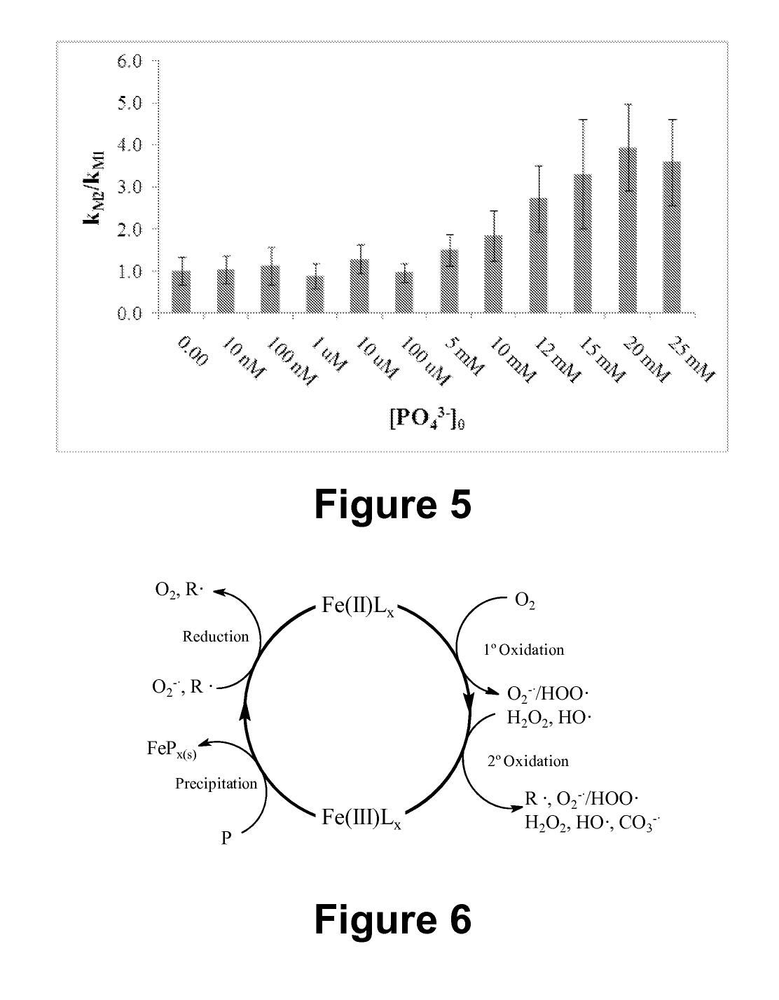

Experimental Design. Experimental parameter space was constructed from the variables Cl⁻, Br⁻, Fe(II), (CO₃²⁻)ₜₒₜ, SRNOM; patterned using the circumscribed Box-Wilson experimental design with concentrations bracketing the range representing the freshwater and saltwater end members (Table 5). The design required six replicate experiments at the center point and three replicate experiments under all other conditions. The overall experimental matrix contained a series of 43 experimental conditions in the defined parameter space (Design Expert version 7.0.2, Stat-Ease Inc., Minneapolis, Minn.), for a total of 132 experiments including replicates. Two experimental matrices were performed; matrix 1 (M1) with no added phosphate, and matrix 2 (M2) made up in 12 mM phosphate. Solutions were prepared for both using a customized J-Kem Eclipse fluid handling station (relative volumetric standard deviation <1%). pH measurements were made using a Orion 410A pH meter with a Thermo Scientific high ionic strength electrode calibrated with NIST buffers at relevant ionic strengths for all conditions in the experimental design (FIG. 4). All experimental pHs were initially set to a value of 8.00±0.05, 20° C. to minimize effects of varying SRNOM, carbonate and phosphate speciation, and also reduce the effects of the changing hydroxide activity. The solution pH changed by less than 0.1 units over the course of the reactions, presumably because of buffering from phosphate and/or carbonate species. The sequence of experiments was randomized to eliminate time dependent artifacts in execution. All Fe(II) loss was assumed to be a result of oxidation and all experiments were performed under dark conditions. The rate of Fe(II) disappearance for the center point of M1 and M2 under continuous N₂ sparge was obtained over the timescale of the experiments as a blank to insure Fe(II) loss was not from vivianite precipitation (FIG. 5).

Iron(II) Oxidation. Fe(II) oxidation experiments were performed according to previously published methods, with Fe(II) quenched at the time of sampling by reaction with Ferrozine. The Ferrozine-Fe(II) complex was stable in the presence of PO₄³⁻ over the timescale of the measurements (FIG. 6).

HO Probe Experiments. Aqueous DCTCB and FCBP were added to replicates of the at midpoint conditions for both M1 and M2 in sufficient quantity to bring their concentration to 1 μM. The appropriate (to midpoint) quantity of Fe(II) was added and their subsequent degradation monitored as evidence for the presence of HO. DCTCB and FCBP were analyzed according to published methods.

### Results

Fe(II) oxidized rapidly under all conditions for M1 and M2. Fe(II) oxidation was first order in Fe(II) for all conditions (FIG. 4, mean r²=0.98, n=264 including all replicates). A series of experiments were conducted at the M1 midpoint condition (Table 5) in the presence of varying concentrations of added PO₄³⁻ (FIG. 5). The addition of phosphate had no detectable effect on the outcome measured as the relative rate of Fe(II) oxidation at [PO₄³⁻]_{O}≦[Fe(II)]_{O}. At higher phosphate loading, with a large excess of phosphate relative to Fe(II), there was an increase in the apparent rate of Fe(II) oxidation that plateaued at approximately 12 mM added PO₄³⁻ (at the 95% level of confidence). This observation was in accordance with loss of the reduction term (Eqn 1).

The net oxidation of Fe(II) in the complex mixture was determined in the presence of five covarying factors; Cl⁻, Br⁻, CO₃²⁻, Fe(II), and SRNOM (M1 and M2; Table 5). The factors were varied across five concentration levels in the combinations required by the central composite (Box-Wilson) experimental design for both experimental matrices save for the addition of 12 mM PO₄³⁻ to M2. The addition of PO₄³⁻ resulted in a net increase in oxidation rate under all conditions. The PO₄³⁻ level was set high enough to stoichiometrically ensure complexation of Fe(III) (99+%) produced during the oxidation so its effect on the kinetics of net Fe(II) oxidation would be constant (FIG. 5). The experimentally determined rate (k) of Fe(II) oxidation for a given matrix (k_{M1}, or k_{M2}) was determined at t_{1/2} for all conditions (Table 6). The relationship between k_{M1}, or k_{M2} and the five parameters was evaluated by fitting a full quadratic expression to a response surface describing the observable vs. the five factors and all of their possible interactions (Eqn. 2, Table 7, corresponding ANOVA). The expressions for both matrices included the five molecular factors (x₁, x₂, x₃, x₄, x₅), a constant term (β₀), linear coefficients for each factor (β₁, β₂, β₃, β₄, β₅) squared coefficients for each factor (β₁₁, β₂₂, β₃₃, β₄₄, β₅₅), and cross-product coefficients to test for possible interactions between factors (β₁₂, β₁₃, β₁₄, β₁₅, β₂₃, β₂₄, β₂₅, β₃₄, □ β₃₅, □ β₄₅) (Table 7):

log k=β₀+β₁x₁+β₂x₂+β₃x₃+β₄x₄+β₅x₅+β₁₁x₁²+β₂₂x₂²+β₃₃x₃²+β₄₄x₄²+β₅₅x₅²+β₁₂x₁x₂+β₁₃x₁x₃+β₁₄x₁x₄+β₁₅x₁x₅+β₂₃x₂x₃+β₂₄x₂x₄+β₂₅x₂x₅+β₃₄x₃x₄+β₃₅x₃x₅+β₄₅x₄x₅ (14)

Both response surfaces correlated with the observed outcomes with r² values of 0.91.

The significance of each factor (βₓ) to the observed outcome (k) was determined by conducting a t-test of the hypothesis that βₓ≠0. Factors that were not significantly different from zero at the 95% level of confidence were considered statistically and practically unimportant to the outcome. The sign of βₓ indicated the direction of its action, with a positive coefficient contributing to an increase in k and a negative coefficient contributing to a decrease in k. The practical importance of the statistically significant factors to k was then determined by calculating their individual percent impacts based on the ratio of the sum of squares of the factor over that of the model. The percent impact of each factor (Table 7) was effectively the percent contributions of each estimated parameter to the sum of squares of the model, and therefore the r² for the model. Thus, the percent impact was a practical measure of the explanatory power of each parameter in accounting for the variation in response about the mean across the design space. A major factor was defined for discussion as being statistically significant (p≦0.05) and having a percent impact ≧5% on the magnitude of k at the 95% level of confidence. Minor factors were statistically significant with less than a 5% impact on the magnitude of k. The major positive factors for M1 were CO₃²⁻ (56%) and the Cl⁻-Br⁻ interaction (7%). The major inhibiting or negative factors were Cl⁻ (12%) and Fe(II) (16%). The positive factors for M2 (Table 3) were CO₃²⁻ (40%) and SRNOM (13%), while (27%) and Fe(II) (10%) were inhibitors. The two matrices were compared to extract information about the net rate and mechanism of Fe(III) reduction.

DCTCB and FCBP (1 μM) were added to the midpoint conditions of each matrix (Table 5) to determine the effect of phosphate on the co-degradation of organics. Fe(II) oxidation was monitored in addition to the probe molecule degradation. Probe degradation was pseudo-first order in the absence of PO₄³⁻, as determined by the plots of In([probe]ₜ/[probe]₀) versus time. In the presence of 12 mM PO₄³⁻ (k_{M2}), both DCTCB and FCBP loss halted after ˜15 min with less than 5% degraded, whereas in the absence of PO₄³⁻ (k_{M1}) both molecules continued to degrade for at least 60 min (DCTCB in FIG. 4). These results are consistent with the finding of HO reported in previous published work based on different matrix designs that did not include variable Fe(II) or the addition of phosphate.

### Discussion

Reductionist models for describing net Fe(II) oxidation by dioxygen at low concentrations (i.e. nanomolar or less) are typically summative expressions of the family of associated reactions with the general form (Eqn. 3):

$$- {( \frac{d [ Fe ( II ) ]}{d t} )}_{net} = \sum {k}_{ox} [ Fe ( II ) {L}_{x} ] [ oxidants ] \qquad ( 15 )$$

where kₒₓ is the bimolecular rate constant for the oxidation of Fe(II) species [Fe(II)Lₓ] (L indicates ligand) by various oxidants (including dioxygen and secondary oxidants). The fundamental assumptions behind this approach are that Fe(II) oxidation is essentially an irreversible process on the time scale of the experiment, and that the role of ligands (or other dissolved species) in affecting the rate is usually a function of their effect on Fe(II) speciation. Such models are successful because the impact of the feedback term (Eqn. 16) falls below the level of the noise typically encountered when monitoring this system and so can be neglected during integration. However, systems with higher initial concentrations of Fe(II) require experimental strategies that can accommodate feedback. In this study, the role of feedback was actually emphasized by the use of experimental designs were Fe(II) was co-varied with other species. Multifactorial designs are uniquely suited for feedback detection in complex matrices because the fitting process identifies the sign (or directionality) of the impact of a given factor or factor-factor interaction.

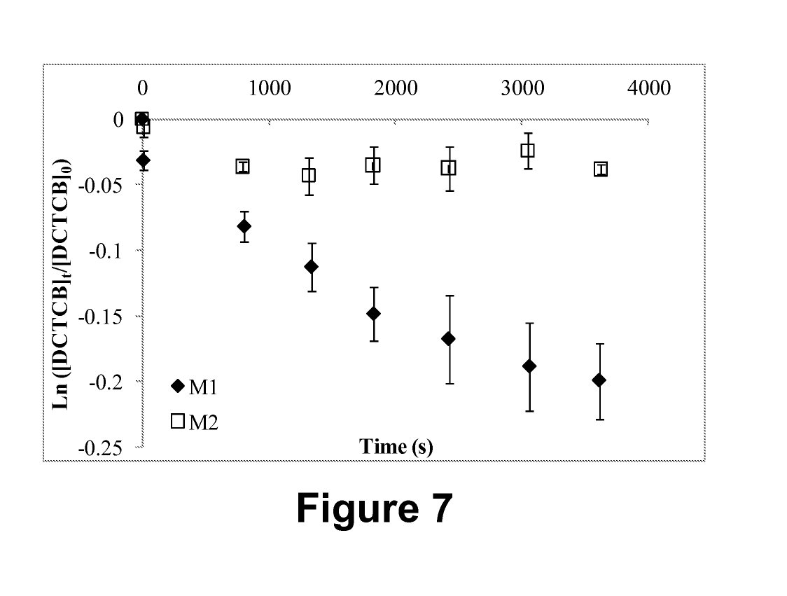

Feedback, or inhibition of Fe(II) oxidation as a result of the presence of Fe(II), was demonstrated by the negative value of β₃ in M1 and M2 and corresponding percent impact (≧5%) (Table 5). It is a summative term that includes not only the direct back reaction between Fe(III) and superoxide but also the reduction of Fe(III) by other reductants in the system, such as those generated during the degradation of SRNOM. Together these values indicated that across the concentration range of Fe(II) encountered in this experimental design (20 μM-200 μM) the oxidation of Fe is at least in part a cyclic process (FIG. 6). Mechanistically, this is consistent with the idea that Fe(III) produced during oxidation was (through reaction with various co-generated reductants) also a source of Fe(II). This observation was also supported by the relative difference in rates between M1 and M2. The rate of Fe(II) loss was faster in M2 than in M1 under all conditions tested. This was because Fe(III) generated during the oxidation was complexed by phosphate and removed from the cycle, leading to a reduction in the magnitude of the feedback term (Eqn. 16). The finding is particularly intriguing in the context of previously published work demonstrating evolution of reactive oxygen species (ROS) during this process. It implies that in the absence of phosphate, natural waters with high Fe(II) loadings (e.g. some anoxic groundwaters, hydrothermal vent fluids, etc) may potentially experience brief periods of high ROS production as they equilibrate with atmospheric oxygen. However the addition of a molar excess of phosphate to those systems could eliminate cycling and reduce net ROS production, in keeping with the observed effect of phosphate on the loss of DCTCB and FCPB (FIG. 7). Presumably the ultimate electron donor in these systems is NOM, however the implied intermediacy of ROS between SRNOM and k_{M1} or k_{M2} in this system made it nearly impossible to directly correlate SRNOM and Fe(II) oxidation rates in environmentally relevant mixtures.

The Fe(II) concentration “cutoff” for the feedback effect can be calculated by comparing the magnitude of the β₃[Fe(II)] (Eqn. 14) term as a function of initial Fe(II) concentration to the standard error of the intercept of the models (β₀ values from Table 7). At conditions with lower initial concentrations of Fe(II), the value of β₃[Fe(II)] will begin to approach the value of the standard error of β₀. At the point those values are no longer significantly different the concentration Fe(II) will cease having detectable effect on the system; i.e. the “signal” from Fe(II) will have fallen into the “noise” of the model. The calculated “effect cutoff” obtained from this analysis is approximately 3.5-4.0 μM for both matrices. Given that the feedback process is associated with the production of ROS, knowing the cutoff concentration is critical for understanding how carbon cycling and Fe cycling interact under situations where Fe(II) rich groundwater is aerated or mixed with aerated surface waters.

There were no statistically significant, major terms (≧5%) that indicated a direct interaction between Fe(II) and any other factors in both M1 and M2, although that would have been expected if Fe(II) complexation were significant to the oxidation process in this system. Speculatively, this could indicate the terms that were important to the process were important because of their effects on Fe(III), not Fe(II). Since Fe(III) was not a controlled factor in the system, this interaction would have appeared in the analysis as significance for a single factor (e.g. CO₃²⁻ or β₄) but not a mixed factor (e.g. Fe(II)-CO₃²⁻ or β₃₄). Therefore in this system the measured significance of the CO₃²⁻ term may have indicated that the precipitation of Fe₂(CO₃)₃ accelerated net Fe(II) removal in the same manner proposed for phosphate. This hypothesis was consistent with the observation of reduced percent impact of CO₃²⁻ in the presence of phosphate (Table 7), since added phosphate would have competed (kinetically) with CO₃²⁻ for Fe(III) ions. Similarly, the retarding effects of chloride would be expected to be more obvious in a system driven by rapid precipitation, given that it yields more soluble complexes of Fe(III). The selective role of SRNOM as an accelerating factor in M2 but not M1 was less clear. Speculatively, stripping of native metals from SRNOM by complexation with phosphate prior to the beginning of the experiment could have resulted in the generation of Fe(III) binding sites not present in

These findings do not necessarily disagree with previous observations that Fe(II) speciation has important effects on oxidation rates at lower concentrations of Fe(II). It was notable that there were some statistically significant, minor (percent impact ≦5%), effects attributable to Fe-factor interactions. However, none of them (including Fe-NOM) exceeded an overall 2.5% impact on the outcome on the scale of the current experiments. Presumably, at Fe(II) concentrations descending to the Fe(II) feedback cutoff the terms describing the effects of Fe(II) complexation on the oxidation rate will become more important to the overall outcome. There is significant uncertainty regarding the cutoff concentration since it is based on the experimental results from the 20 μM-200 μM Fe(II) concentration range in the experimental design and falls outside that range.

### Example 3

An empirical, combinatorial investigation of Fe(II) oxidation that evaluated these variations across the pH, Fe(II), PO₄³⁻, Cl⁻, Br⁻, CO₃²⁻ and natural organic matter (NOM) axes. The work assayed the effects of independent and dependent variables simultaneously through application of a novel experimental design that varied Fe(II), PO₄³⁻, Cl⁻, Br⁻, and CO₃²⁻ along the pH axis. Each factor was varied across concentration ranges corresponding to the natural variation between typical fresh and salt water. Factors and interfactor interactions were statistically evaluated to determine their importance to Fe(II) oxidation at the 95% level of confidence. Significant factors were used to construct predictive numerical models of Fe(II) oxidation rates. Two models (M1 and M2) were constructed to represent the conditional endmembers of unrestricted Fe cycling (M1) and restricted Fe cycling (due to forced precipitation of Fe(III), M2). The models were challenged to predict Fe(II) oxidation rates across a watershed (the Congaree/Santee rivers, sampled at ten different locations in South

Carolina). Both models were capable of predicting Fe(II) oxidation rates to within the 95% confidence interval at all of the tested points, although M2 consistently over predicted the rate relative to M1.

### Experimental Methods

Materials. All salts (99%) were obtained from Fisher Scientific. FerroZine® iron reagent (98%) was purchased from VWR. Suwannee River NOM (SRNOM) was acquired from the International Humic Substances Society (IHSS) (Supp. Tables 1-4). All reagents were used as received. Solutions were made in Barnstead E-pure (18 MΩcm⁻¹) water which had been distilled to remove trace H₂O₂.

Experimental Design. Factors were included in the experimental designs based on their published effects on the net rate of Fe(II) oxidation. The composition and order of the individual experiments was determined using a circumscribed Box-Wilson experimental design (central composite design with five concentration levels, Table 8). Concentration levels were set to bracket the ranges expected to be found in surface waters ranging from fresh to saline. The design layout and data analysis were performed using Design Expert (version 7.0.2). Two series of experimental matrices (M1 and M2) were examined. M1 was a five-factor central composite design that included Cl⁻, Br⁻, Fe(II), CO₃²⁻, and SRNOM; and was repeated in its entirety at pH 6.5, 7.0, 7.5, 8.0, and 8.5. M2 was a six-factor central composite design representing conditions that forced precipitation by the addition of PO₄³⁻ as the sixth variable. This was also repeated at pH 6.5, 7.0, 7.5, 8.0, and 8.5. Solutions were prepared for both using a customized J-Kem Eclipse fluid handling station (relative volumetric standard deviation <1%). A pH probe was calibrated at relevant ionic strengths corresponding to conditions in the experimental design and used for all pH measurements (Orion 410A pH meter with a Thermo Scientific high ionic strength electrode). All conditions were performed in triplicate with the exception of the center points. At the center point of M1; n=6, and for M2, n=10, as required by the design algorithm. The sequence of experiments was randomized to eliminate time dependent artifacts. The effects of pH were determined by performing complete multivariate matrices for each pH value ±0.05 (6.50, 7.00, 7.50, 8.00, and 8.50). The effects of each factor and interaction at each pH were compared to determine trends over the pH range.

Iron(II) oxidation experiments. Fe(II) oxidation experiments were performed according to previously published methods, with Fe(II) quenched at the time of sampling by reaction with Ferrozine.

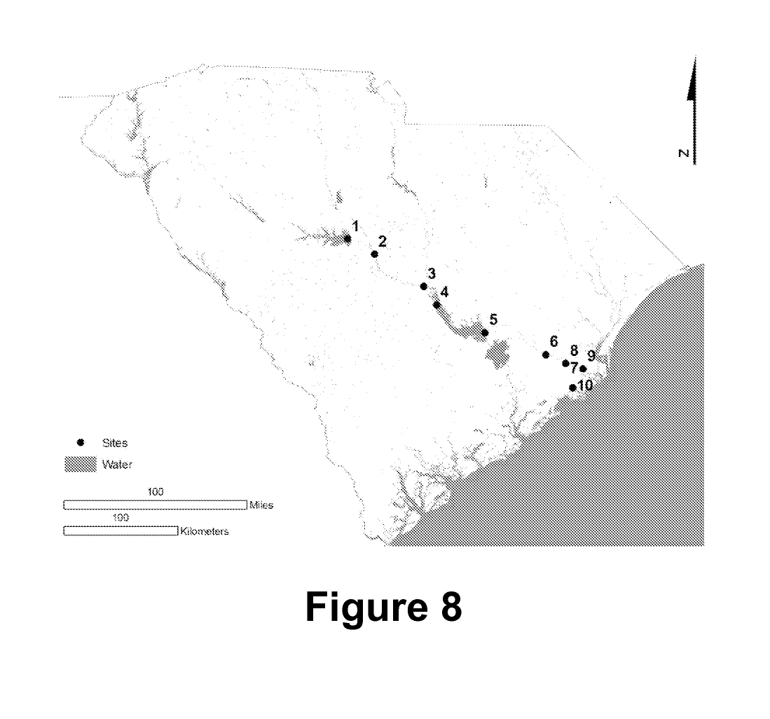

Natural water experiments. Water samples were taken from various sampling sites between Lake Murray, S.C. (fresh) and Mclellanville, S.C. (saline) (FIG. 8). All samples were taken in BOD bottles that had been cleaned in a muffle furnace and then acid washed. Sample collection bottles were triply rinsed with the water samples prior to collection. Each surface water sample was split into two fractions one which was unfiltered and a second which was filtered using a 0.2 micron Acrodisc syringe filter. Both fractions were spiked with 65 μM Fe(II). Fe(II) oxidation experiments were run within 24 hr according to previously published methods. All other analyses were run within 48 hr. The samples were analyzed for Cl⁻ (Thermo Scientific conductivity meter), total organic carbon and total carbonate (Shimadzu TOC 5000a analyzer), Fe(II)/Fe(III) (Ferrozine), PO₄³⁻ (modified EPA method 365.3), and pH (Thermo Scientific high ionic strength electrode).

### Results

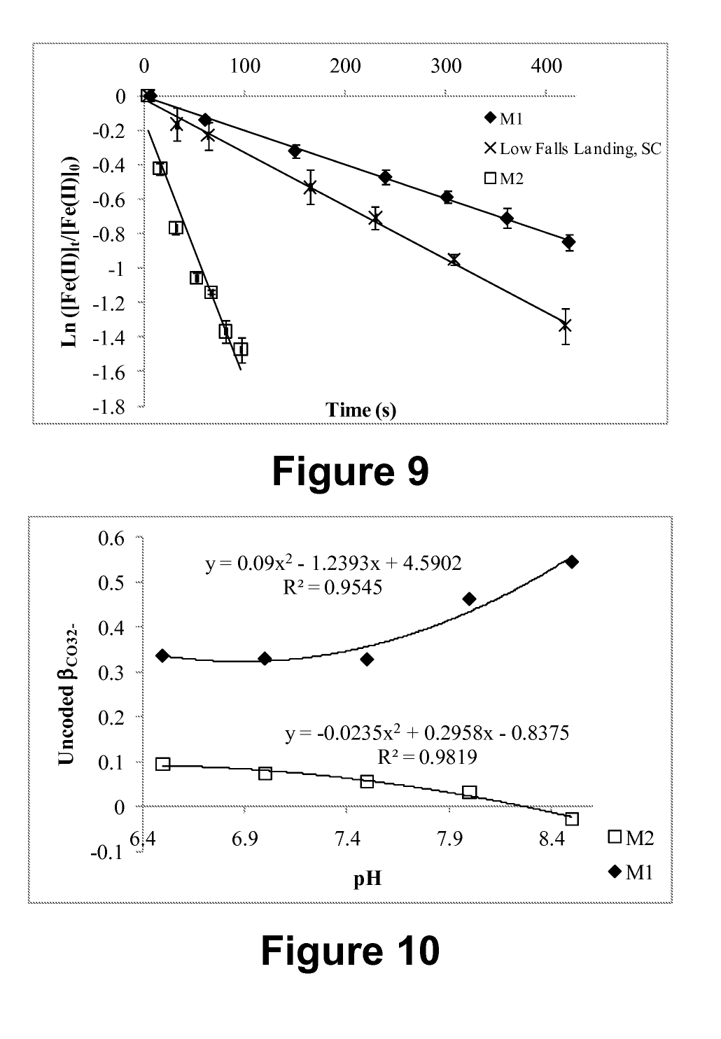

Fe(II) oxidation was first order in Fe(II) for both M1 and M2 at every pH (6.5, 7.0, 7.5, 8.0, and 8.5). The experimental rate (k) for Fe(II) oxidation from either matrix (k_{M1} or k_{M2}) were determined at its first half life from the slope of the line obtained by plotting the In ([Fe(II)]ₜ/[Fe(II)]_{O}) vs time (at every condition, FIG. 9; mean r²=0.98, n=1,804 including all replicates).

The relationship between the parameters in Table 8 and the log of the rate of Fe(II) oxidation k was evaluated by fitting a full quadratic expression to the response surface for each pH (Eqn. 17). The expression included factor concentrations (x₁, x₂, x₃, x₄, x₅), a constant term (β₀), linear coefficients for each factor (β₁, β₂, β₃, β₄, β₅), squared coefficients for each component (β₁₁, β₂₂, β₃₃, β₄₄, β₅₅) and cross-product coefficients to test for possible interactions (β₁₂, β₁₃, β₁₄, β₁₅, β₂₃, β₂₄, β₂₅, β₃₄, β₃₅, β₄₅) (Eqn. 17):

log k=β₀+β₁x₁+β₂x₂+β₃x₃+β₄x₄β₅x₅+β₁₁x₁²+β₂₂x₂²+β₃₃x₂²+β₄₄x₄²+β₅₅x₅²+β₁₂x₁x₂+β₁₃x₁x₃+β₁₄x₁x₄+β₁₅x₁x₅+β₂₃x₂x₃+β₂₄x₂x₄+β₂₅x₂x₅+β₃₄x₃x₄+β₃₅x₃x₅+β₄₅x₄x₅ (17)

The statistical significance of each individual factor and factor interaction to k was determined by conducting a t-test of the hypothesis that the corresponding coefficient βₓ≠0. Factors with coefficients that were not significantly different from zero at the 95% level of confidence were considered statistically and practically unimportant to the outcome. The sign of βₓ indicated the direction of the significant factors' action, with a positive coefficient contributing to an increase in k and a negative coefficient contributing to a decrease in k. Factors that were statistically significant to the outcome of M1 at every pH were Cl⁻, Fe(II), CO₃²⁻, (CO₃²⁻)², and the Cl⁻-SRNOM interaction. Factors that were statistically significant to the outcome of M2 at every pH were Cl⁻, Fe(II), CO₃²⁻ and PO₄³⁻. The practical importance of the statistically significant factors to k was then determined by calculating their individual percent impacts based on the ratio of the sum of squares of the factor over that of the model. Major factors were arbitrarily defined as those with % impacts ≧5%; minor factors were defined as those with % impact <5%. The major factors (on average) that correlated to the outcome of M1 at every pH were Cl⁻, Fe(II), and CO₃²⁻. The same factors were significant for every pH in M2, with the addition of the major factor PO₄³⁻.

This process was used as a strategy to simplify the resulting model surfaces. Surfaces (for M1 and M2) were recalculated at every pH using only the relationship between k and the previously identified significant factors (Cl⁻, Fe(II), CO₃²⁻, and PO₄³⁻). The effect of pH on the resulting coefficients (βₓ) was determined empirically by plotting βₓ vs pH for both M1 and M2 and fitting the corresponding curves (Table 9, FIG. 10). A predictive model describing the rate of Fe(II) oxidation across the pH range 6.5-8.5 was then generated using the pH dependent βₓ expressions (uncoded βₓ: Eqns. 18-19; coded βₓ):

log k_{M1,P}=(−0.2901 pH²+4.5364 pH−20.38)+(0.0003 pH²−0.0045 pH+0.0164)[Cl⁻]_{O}+(−0.0004 pH²+0.0047 pH−0.0181)[Fe(II)]_{O}+(0.09 pH²−1.2393 pH+4.5902)[CO₂^{-2]}_{O} (18)

log k_{M2,P}=(−0.6244 pH²+10.263 pH−43.495)+(0.001 pH−0.0083)[Cl⁻]_{O}+(0.0023 pH³−0.0523 pH²+0.3873 pH−0.9468)[Fe(II)]_{O}+(−0.0235 pH²+0.2958 pH+0.8375)[CO₃⁻²]_{O}+(0.0154 pH³+0.3514 pH²−2.6605 pH+6.7165)[PO₄^{3-]}_{O} (19)

The validity of using parameter-space based empirical models to predict Fe(II) oxidation across a wide range of environmental conditions/locations was tested. The models (Eqns 18-19) were challenged to predict the rate of Fe(II) oxidation at ten different geographical locations progressing downstream in the main channel of the Congaree-Santee River system in South Carolina in raw and filtered (0.2 μ) waters. Samples were analyzed for⁻the significant factors identified in M1 and M2 and the corresponding measured values entered in Eqn. 18 and Eqn. 19 (pH=6.85-8.31, [Cl⁻]=0.99 mM-353 mM; Table 3). The rate of Fe(II) oxidation was predicted (k_{P}) for the two conditional endmembers: k_{M1,P} corresponding to the model based on unrestricted cycling, and k_{M2,P} based on cycling restricted by complexation of Fe(III) with strong ligands. Fe(II) was spiked into raw and filtered water samples. Its disappearance was first order in Fe(II) for both sample types (FIG. 9). The experimental rates obtained were compared against those predicted from Eqn 18 and Eqn 19 (Table 10). Measured rates (raw and filtered) and predicted rates from Eqn. 18 (k_{M1,P}) agreed within the 95% confidence interval for all sites except the Pleasant Hill Cypress Swamp (site #8) and

Mclellanville (site #10). In the case of Eqn. 19 (k_{M2,P}), all measured rates (raw and filtered) and predicted rates agreed within the 95% confidence interval with the exception of the Pleasant Hill Cypress Swamp (site #8).

### Discussion

Contrasting multifactorial experiments developed in this paper generated empirical descriptive models that could be used with broad predictive power and also afforded insight about the fundamental nature of the Fe(II) oxidation process within the concentration ranges set forth for the factors in M1 and M2. The models were tested for their ability to describe Fe(II) oxidation in an extensive watershed; the Congaree/Santee rivers across a geographic region stretching 230 km from the foothills of the Appalachians to the Atlantic coast. They were used to predict the rate of oxidation of added Fe(II) in surface waters across that region and generally did so within the 95% level of confidence. The exceptions were water samples corresponding geographically to the cypress swamp water samples at Pleasant Hill Landing (both models) and McClellanville (M1). Fe(II) oxidized in the Pleasant Hill Cypress Swamp water approximately a factor of three times more rapidly than expected based on the models. Speculatively, this was attributable to a very high concentration of Fe(III)-binding ligands present in this water causing cycling to be restricted beyond what is accounted for in either the M1 or M2 model. The presence of these ligands is supported by the high concentration of filterable Fe(III) in this water (-140 μM). The rate of Fe(II) oxidation in the McClellanville sample was successfully predicted using the restricted cycling model (M2) but not the unrestricted model (M1). The site is downstream of a shellfish processing facility and had the highest TOC of all sites sampled. It is possible that a component of TOC was a significant factor at this site [i.e. uncharacterized strong ligand(s)] even though in bulk it was not a significant factor.

The oxidation of aqueous Fe(II) to Fe(III) is often described by two different mechanisms in the literature; a cyclic process where Fe may cycle between the (II) and (III) oxidation states several times before net oxidation and a direct oxidation where oxidation of Fe(II) is essentially irreversible. Cycling was favored under the M1 conditions at all pHs as indicated by the consistent negative impact of the initial Fe(II) concentration on the net Fe(II) oxidation rate (i.e. β_{Fe(II)} is always negative in M1). This is consistent with previously published work indicating that Fe(II) oxidation results in HO. production in aqueous systems. HO. production in the presence of sacrificial organics such as NOM is known to lead to the formation of superoxide. Superoxide is also generated during Fe(II) oxidation by O₂. The bimolecular rate constant for the reduction of Fe(III) to Fe(II) by superoxide (1.5×10⁸ M⁻¹s⁻¹) is competitive with other superoxide losses (e.g. net dismutation by reaction with the hydroperoxyl radical, 1.02×10⁸ M⁻¹s⁻¹) under the pH conditions of our study. We hypothesize this observation explains the negative values of β_{Fe(II)}; high initial levels of Fe(II) lead to high levels of generated Fe(III), making Fe(III) a more effective sink for superoxide with an apparent inhibitory effect on Fe(II) oxidation rate. In contrast, β_{Fe(II)} for M2 does not show a consistent pattern across pH, in agreement with the idea that cycling is restricted in the presence of ligands that can trap Fe(III). Unfortunately the direct role of NOM as a superoxide source is not quantifiable in this work, since superoxide production is several steps removed from the observable.

This observation allows reconciliation between cyclic and linear models for net Fe(II) oxidation through analysis of the magnitude of β_{Fe(II)} in M1. The initial concentration of Fe(II) only had a significant contribution to k when the product β_{Fe(II)}[Fe(II)] was high enough to exceed the error associated with the constant (or intercept) of the model, β₀. Since the contribution of [Fe(II)] to the outcome was the product of its concentration and the corresponding β_{Fe(II)} coefficient (Eqn. 17), this meant there was a threshold (or concentration) below which it had no measurable impact. The minimum initial concentration of Fe(II) required to have a significant (negative) impact on M1 varied from 5 μM to 25 μM across the pH range of the experiment. This suggests that at lower initial concentrations of Fe(II), insufficient Fe(III) is produced to compete against dismutation for superoxide (consistent with the hypothesis above). Scavenging relationships in free radical chemistry are typically relative and S-shaped, in that there are large, low concentration regions where scavenging is flat; a mid level range where scavenging is dynamic and a high range where the system is saturated. Speculatively, a model of net Fe(II) oxidation based on the relative efficiency by which Fe(III) scavenges superoxide provides an axis to resolve historical perspectives of Fe(II) oxidation in dilute solution (e.g. linear models of seawater) and at relatively high concentrations (e.g. cyclic models of cytosols, anoxic groundwaters, etc). This also provides an explanation for some of the differences observed when previous investigations have correlated source and type of NOM against Fe(II) oxidation rates. The presence of heteroaliphatic carbon, particularly polyfunctional carboxylic acids, has been correlated to increased rates of net Fe(II) oxidation. Multidentate carboxylate based ligands often have high stability constants with Fe(III) and are poorly labile. Organically complexed Fe(III) is often more difficult to reduce (kinetically) than Fe(III) aquo complexes. These observations, from a cycling perspective, suggest the role of organic matter during Fe(II) oxidation is a complex function of a) providing superoxide generated as a product of the free radical oxidation of NOM, and b) protecting Fe(III) from reduction by superoxide.

TABLE 4
Parameter Estimates and Hypothesis Tests for the Parameters of the Quadratic
Model Fitted to the Log Transformed Data for the Number of Fe(II) Cycles^{a}

| | | coefficient | standard | | | |
|---|---|---|---|---|---|---|
| | | estimate | error | F | p value | % |
| parameter | β [symbol] key | (×10⁻²) | (×10⁻²) | value | (p > F) | contribution |
| β₀ | intercept | 201.9 | 6.26 | 21.8 | <0.0001^{b} | |
| β₁ | [Cl⁻] | 2.86 | 2.00 | 2.04 | 0.1559 | 0.47 |
| β₂ | [Br⁻] | 32.7 | 2.00 | 268 | <0.0001^{b} | 61.3 |
| β₃ | [I⁻] | 0.96 | 2.00 | 0.23 | 0.6330 | 0.05 |
| β₄ | [CO₃²⁻]ₜₒₜ | −11.2 | 2.00 | 31.3 | <0.0001 [symbol] | 7.15 |
| β₅ | SRNOM | 0.53 | 2.00 | 0.07 | 0.7921 | 0.02 |
| β₁₂ | [Cl⁻]—[Br⁻] | −2.31 | 2.17 | 1.140 | 2890 | 0.26 |
| β₁₃ | [Cl⁻]—[I⁻] | 0.27 | 2.17 | 0.02 | 0.9006 | 0.004 |
| β₁₄ | [Cl⁻]—[CO₃²⁻]ₜₒₜ | −3.85 | 2.17 | 3.15 | 0.0785 | 0.72 |
| β₁₅ | [Cl⁻] - SRNOM | 6.47 | 2.17 | 8.92 | 0.0035^{b} | 2.04 |
| β₂₃ | [Br⁻]—[I⁻] | −1.50 | 2.17 | 0.48 | 0.4891 | 0.11 |
| β₂₄ | [Br⁻]—[CO₃²⁻]ₜₒₜ | 7.56 | 2.17 | 12.2 | 0.0007^{b} | 2.78 |
| β₂₅ | [Br⁻] - SRNOM | −7.44 | 2.17 | 11.8 | 0.0008^{b} | 2.70 |
| β₃₄ | [I⁻]—[CO₃²⁻]ₜₒₜ | 1.79 | 2.17 | 0.69 | 0.4096 | 0.16 |
| β₃₅ | [I⁻] - SRNOM | 4.30 | 2.17 | 3.93 | 0.0499^{b} | 0.90 |
| β₄₅ | [CO₃²⁻]ₜₒₜ - SRNOM | 3.86 | 2.17 | 3.18 | 0.0773 | 0.73 |
| β₁₁ | [Cl⁻]² | 12.2 | 3.14 | 15.1 | 0.0002^{b} | 3.47 |
| β₂₂ | [Br⁻]² | −20.4 | 3.14 | 42.3 | <0.0001^{b} | 9.67 |
| β₃₃ | [I⁻]² | 7.44 | 3.14 | 5.61 | 0.0195^{b} | 1.29 |
| β₄₄ | [CO₃²⁻]ₜₒₜ² | 15.5 | 3.14 | 24.5 | <0.0001^{b} | 5.60 |
| β₅₅ | SRNOM² | 5.08 | 3.14 | 2.62 | 0.1085 | 0.60 |

^{a}This is for the coded factor levels from Table 1.
^{b}Tests as significant at the 95% confidence level. [symbol]
indicates data missing or illegible when filed

TABLE 5
Design points for the five-factor central composite
design used in all experiments. M1 and M2 were identical save
for the addition of 12 mM PO₄³⁻ to M2.

| Factor (units) | Factor Concentration Levels^{a} | | | | |
|---|---|---|---|---|---|
| Coded Factor Levels | −2 | −1 | 0 | 1 | 2 |
| x₁: [Cl⁻] (mM) | 0.00 | 155 | 388 | 621 | 776 |
| x₂: [Br⁻] (μM) | 0.00 | 209 | 525 | 841 | 1050 |
| x₃: [Fe(II)]ₒ (μM) | 20.0 | 55.8 | 110 | 164 | 200 |
| x₄: [CO₃²⁻]ₜₒₜ (mM) | 0.30 | 0.87 | 1.73 | 2.58 | 3.15 |
| x₅: [SRNOM] (mg C/L) | 0.00 | 3.19 | 8.00 | 12.8 | 16.0 |

^{a}Denotes initial concentrations

TABLE 6
Conditions and corresponding rate constants for Fe(II) oxidation (n =
3 for exp. conditions 1-42, n = 6 for the midpoint at exp. condition 43).

| | | | | | | Average | ^{a}Average |
|---|---|---|---|---|---|---|---|
| Exp. | [Cl⁻] | [Br⁻] | [CO₃²⁻]ₜₒₜ | SRNOM | [Fe(II)]ₒ | k_{M1} (s⁻¹) × | k_{M2} (s⁻¹) × |
| condition | (mM) | (μM) | (mM) | (mg C/L) | (μM) | 10⁻³ | 10⁻³ |
| 1 | 0 | 525 | 1.73 | 8.00 | 111 | 11.3 ± 0.10 | 14.9 ± 2.87 |
| 2 | 155 | 209 | 0.87 | 3.19 | 55.8 | 5.77 ± 0.91 | 5.30 ± 0.68 |
| 3 | 155 | 209 | 0.87 | 12.81 | 55.8 | 3.10 ± 0.53 | 8.47 ± 1.43 |
| 4 | 155 | 209 | 2.58 | 3.19 | 55.8 | 15.3 ± 0.10 | 13.7 ± 0.45 |
| 5 | 155 | 209 | 2.58 | 12.81 | 55.8 | 38.8 ± 9.00 | 53.7 ± 8.79 |
| 6 | 155 | 209 | 0.87 | 3.19 | 164 | 1.93 ± 0.31 | 6.07 ± 0.24 |
| 7 | 155 | 209 | 0.87 | 12.81 | 164 | 0.90 ± 0.10 | 7.43 ± 0.64 |
| 8 | 155 | 209 | 2.58 | 3.19 | 164 | 2.67 ± 0.32 | 8.26 ± 0.81 |
| 9 | 155 | 209 | 2.58 | 12.81 | 164 | 3.13 ± 0.15 | 12.4 ± 0.88 |
| 10 | 155 | 841 | 0.87 | 3.19 | 55.8 | 1.47 ± 0.06 | 7.80 ± 0.52 |
| 11 | 155 | 841 | 0.87 | 12.81 | 55.8 | 1.70 ± 0.36 | 12.6 ± 1.55 |
| 12 | 155 | 841 | 2.58 | 3.19 | 55.8 | 6.57 ± 1.63 | 17.7 ± 0.44 |
| 13 | 155 | 841 | 2.58 | 12.81 | 55.8 | 9.30 ± 1.97 | 37.4 ± 7.18 |
| 14 | 155 | 841 | 0.87 | 3.19 | 164 | 0.63 ± 1.15 | 8.30 ± 0.54 |
| 15 | 155 | 841 | 0.87 | 12.81 | 164 | 0.53 ± 0.06 | 12.0 ± 0.91 |
| 16 | 155 | 841 | 2.58 | 3.19 | 164 | 5.53 ± 0.85 | 12.2 ± 0.78 |
| 17 | 155 | 841 | 2.58 | 12.81 | 164 | 6.40 ± 0.27 | 16.7 ± 2.02 |
| 18 | 388 | 0.00 | 1.73 | 8.00 | 110 | 2.03 ± 0.35 | 8.59 ± 1.33 |
| 19 | 388 | 525 | 1.73 | 8.00 | 20.0 | 9.43 ± 0.93 | 10.2 ± 1.10 |
| 20 | 388 | 525 | 0.30 | 8.00 | 110 | 0.20 ± 0.01 | 3.28 ± 0.57 |
| 21 | 388 | 525 | 1.73 | 0.00 | 110 | 1.07 ± 0.06 | 5.70 ± 0.56 |
| 22 | 388 | 525 | 1.73 | 16.00 | 110 | 3.10 ± 0.27 | 9.36 ± 0.80 |
| 23 | 388 | 525 | 3.15 | 8.00 | 110 | 7.13 ± 0.68 | 16.3 ± 2.69 |
| 24 | 388 | 525 | 1.73 | 8.00 | 200 | 0.73 ± 0.06 | 4.39 ± 0.82 |
| 25 | 388 | 1050 | 1.73 | 8.00 | 110 | 1.30 ± 0.17 | 6.61 ± 1.05 |
| 26 | 622 | 209 | 0.87 | 3.19 | 55.8 | 0.37 ± 0.06 | 2.93 ± 0.23 |
| 27 | 622 | 209 | 0.87 | 12.81 | 55.8 | 0.57 ± 0.06 | 5.43 ± 0.07 |
| 28 | 622 | 209 | 2.58 | 3.19 | 55.8 | 1.40 ± 0.36 | 7.19 ± 0.30 |
| 29 | 622 | 209 | 2.58 | 12.81 | 55.8 | 6.37 ± 1.26 | 15.2 ± 1.57 |
| 30 | 622 | 209 | 0.87 | 3.19 | 164 | 0.30 ± 0.01 | 1.59 ± 0.26 |
| 31 | 622 | 209 | 0.87 | 12.81 | 164 | 0.40 ± 0.01 | 2.23 ± 0.15 |
| 32 | 622 | 209 | 2.58 | 3.19 | 164 | 2.00 ± 0.30 | 4.02 ± 0.61 |
| 33 | 622 | 209 | 2.58 | 12.81 | 164 | 2.73 ± 0.35 | 9.28 ± 2.11 |
| 34 | 622 | 841 | 0.87 | 3.19 | 55.8 | 1.23 ± 0.1 5 | 3.38 ± 0.35 |
| 35 | 622 | 841 | 0.87 | 12.81 | 55.8 | 1.37 ± 0.23 | 3.96 ± 0.69 |
| 36 | 622 | 841 | 2.58 | 3.19 | 55.8 | 9.60 ± 2.25 | 8.84 ± 0.77 |
| 37 | 622 | 841 | 2.58 | 12.81 | 55.8 | 13.0 ± 2.80 | 25.1 ± 6.31 |
| 38 | 622 | 841 | 0.87 | 3.19 | 164 | 0.47 ± 0.06 | 2.52 ± 0.05 |
| 39 | 622 | 841 | 0.87 | 12.81 | 164 | 0.63 ± 0.07 | 4.48 ± 0.10 |
| 40 | 622 | 841 | 2.58 | 3.19 | 164 | 2.93 ± 0.47 | 5.93 ± 1.34 |
| 41 | 622 | 841 | 2.58 | 12.81 | 164 | 4.07 ± 0.67 | 8.20 ± 1.08 |
| 42 | 776 | 525 | 1.73 | 8.00 | 110 | 1.97 ± 0.15 | 8.26 ± 1.04 |
| 43 | 388 | 525 | 1.73 | 8.00 | 110 | 3.85 ± 0.90 | 10.5 ± 1.82 |

^{a}Conditions 1-43 also contain 12 mM PO₄³⁻

TABLE 7
Parameter Estimates and Hypothesis Tests for the Parameters of the Quadratic
Model Fitted to the Log Transformed Data for net Fe(II) oxidation (k_{M2}).^{a}

| | | coefficient | standard | | | |
|---|---|---|---|---|---|---|
| | | estimate | error | F | p value | % |
| parameter | βₓ key | (×10⁻²) | (×10⁻²) | value | Prob > F | Impact |
| β₀ | intercept | −205 | 2.95 | | | |
| β₁ | Cl⁻ | −16.4 | 0.94 | 303.27 | <0.0001^{b} | 26.83 |
| β₂ | Br⁻ | 4.24 | 0.94 | 20.23 | <0.0001^{b} | 1.79 |
| β₃ | Fe(II) | −10.2 | 0.94 | 116.58 | <0.0001^{b} | 10.32 |
| β₄ | CO₃²⁻ | 20.1 | 0.94 | 455.27 | <0.0001^{b} | 40.28 |
| β₅ | SRNOM | 11.3 | 0.94 | 143.56 | <0.0001^{b} | 12.70 |
| β₁₂ | Cl⁻—Br⁻ | −0.31 | 1.02 | 0.09 | 0.76 | 0.01 |
| β₁₃ | Cl⁻—Fe(II) | −1.61 | 1.02 | 2.47 | 0.12 | 0.22 |
| β₁₄ | Cl⁻—CO₃²⁻ | 3.09 | 1.02 | 9.16 | 0.003^{b} | 0.81 |
| β₁₅ | Cl⁻ - SRNOM | 4.02 | 1.02 | 0.15 | 0.69 | 0.01 |
| β₂₃ | Br⁻—Fe(II) | 2.37 | 1.02 | 5.37 | 0.02^{b} | 0.48 |
| β₂₄ | Br⁻—CO₃²⁻ | −1.41 | 1.02 | 1.90 | 0.17 | 0.17 |
| β₂₅ | Br⁻ - SRNOM | −1.34 | 1.02 | 1.71 | 0.19 | 0.15 |
| β₃₄ | Fe(II)—CO₃²⁻ | −5.59 | 1.02 | 29.93 | <0.0001^{b} | 2.65 |
| β₃₅ | Fe(II) - SRNOM | −2.99 | 1.02 | 8.58 | 0.004^{b} | 0.76 |
| β₄₅ | CO₃²⁻ - SRNOM | 3.45 | 1.02 | 11.41 | 0.001^{b} | 1.01 |
| β₁₁ | (Cl⁻)² | 4.27 | 1.48 | 8.31 | 0.005^{b} | 0.73 |
| β₂₂ | (Br⁻)² | −1.79 | 1.48 | 1.47 | 0.23 | 0.13 |
| β₃₃ | (Fe(II))² | −3.65 | 1.48 | 6.07 | 0.02^{b} | 0.54 |
| β₄₄ | (CO₃²⁻)² | 2.29 | 1.48 | 2.39 | 0.12 | 0.21 |
| β₅₅ | (SRNOM)² | −2.21 | 1.48 | 2.22 | 0.14 | 0.20 |

^{a}This is for the coded factor levels from Table 1;
^{b}tests as significant at the 95% confidence level.

TABLE 8
A) Design points for the five-factor central composite design
used in all experiments (M1). B) Design points for the six-factor
central composite design used in all experiments (M2).
A)

Factor (units) for

| matrix set M1 | Factor Concentration Levels^{a} | | | | |
|---|---|---|---|---|---|
| Coded Factor Levels | −2 | −1 | 0 | 1 | 2 |
| x₁: [Cl⁻] (mM) | 0.00 | 155 | 388 | 622 | 776 |
| x₂: [Br⁻] (μM) | 0.00 | 209 | 525 | 841 | 1050 |
| x₃: [CO₃²⁻]ₜₒₜ (mM) | 0.30 | 0.87 | 1.73 | 2.58 | 3.15 |
| x₄: [Fe(II)] (μM) | 20.0 | 55.8 | 110 | 164 | 200 |
| x₅: [SRNOM] (mg C/L) | 0.00 | 3.19 | 8.00 | 12.8 | 16.0 |

B)

Factor (units) for

| matrix set M2 | Factor Concentration Levels^{a} | | | | |
|---|---|---|---|---|---|
| Coded Factor Levels | −2 | −1 | 0 | 1 | 2 |
| x₁: [Cl⁻] (mM) | 0.00 | 195 | 390 | 585 | 780 |
| x₂: [Br⁻] (μM) | 0.00 | 263 | 525 | 788 | 1050 |
| x₃: [CO₃²⁻]ₜₒₜ (mM) | 0.30 | 1.10 | 1.90 | 2.70 | 3.50 |
| x₄: [SRNOM] (mg C/L) | 0.00 | 4.00 | 8.00 | 12.0 | 16.0 |
| x₅: [PO₄³⁻]ₜₒₜ (mM) | 0.00 | 5.00 | 10.0 | 15.0 | 20.0 |
| x₆: [Fe(II)] (μM) | 20.0 | 65 | 110 | 155 | 200 |

^{a}Denotes initial concentrations

TABLE 9
Uncoded βₓ values for the reduced models corresponding to pH.

| | Factor | | | | | | | | | |
|---|---|---|---|---|---|---|---|---|---|---|
| | M1 βₓ × 10³ | | | | | M2 βₓ × 10³ | | | | |
| pH | 6.5 | 7.0 | 7.5 | 8.0 | 8.5 | 6.5 | 7.0 | 7.5 | 8.0 | 8.5 |
| Intercept | −317 | −279 | −266 | −271 | −275 | −317 | −223 | −166 | −135 | −137 |
| Cl⁻ | −0.36 | −0.69 | −0.78 | −0.77 | −0.64 | −1.75 | −1.06 | −0.94 | 0.026 | 0.244 |
| Fe(II) | −2.80 | −2.77 | −2.64 | −3.93 | −3.81 | 1.09 | 1.40 | −0.33 | −1.38 | −0.96 |
| CO₃²⁻ | 337 | 331 | 329 | 464 | 547 | 95.0 | 73.2 | 56.4 | 32.0 | −27.2 |
| PO₄³⁻ | | | | | | 30.9 | 11.1 | 22.1 | 12.0 | 9.58 |

TABLE 10
Raw natural water experimental rate comparison against predicted rates from both
Eqns. 18 and 19. All samples were spiked with 65 μM Fe(II) at t = 0, n = 3.

| | | [Cl⁻] | [CO₃²⁻] | [PO₄³⁻] | [Fe(II)] | TOC | kₑₓₚ(s⁻¹) × | k_{M1, P} (s⁻¹) × | k_{M2, P} (s⁻¹) × |
|---|---|---|---|---|---|---|---|---|---|
| | | (mM) ± | (mM) ± | (mM) ± | (μM) ± | (mg | 10⁻³ | 10⁻³ | 10⁻³ |
| Site | pH | 1% | 5% | 20% | 2% | C/L) ± 10% | (n = 3) | (df = 3) | (df = 4) |
| 1. Lake | 7.94 | 0.99 | 0.63 | 0.01 | N.D. | 6.32 | 1.26 ± 0.09 | 1.68 ± 0.43 ^{a} | 3.23 ± 2.36 ^{a} |
| Murray | | | | | | | | | |
| 2. Barney | 8.31 | 1.04 | 0.72 | 0.05 | N.D. | 9.55 | 1.51 ± 0.27 | 1.63 ± 0.43 ^{a} | 2.32 ± 2.16 ^{a} |
| Jordan | | | | | | | | | |
| Landing | | | | | | | | | |
| 3. Bates | 7.39 | 1.10 | 0.77 | 0.03 | N.D. | 18.0 | 1.68 ± 0.04 | 1.69 ± 0.52 ^{a} | 3.01 ± 1.59 ^{a} |
| Bridge | | | | | | | | | |
| Landing | | | | | | | | | |
| 4. Low Falls | 7.30 | 1.38 | 1.47 | 0.01 | N.D. | 16.0 | 3.13 ± 0.43 | 2.78 ± 0.88 ^{a} | 3.04 ± 1.54 ^{a} |
| Landing | | | | | | | | | |
| 5. Wilsons | 7.44 | 1.31 | 0.81 | 0.01 | N.D. | 16.4 | 1.67 ± 0.22 | 1.90 ± 0.57 ^{a} | 3.16 ± 1.71 ^{a} |
| Landing | | | | | | | | | |
| 6. Lenuds | 7.31 | 1.55 | 0.63 | 0.01 | N.D. | 10.5 | 1.06 ± 0.02 | 1.45 ± 0.46 ^{a} | 2.69 ± 1.37 ^{a} |
| Landing | | | | | | | | | |
| 7. Pleasant | 7.73 | 1.40 | 0.75 | 0.015 | 1.27 | 17.8 | 2.79 ± 0.79 | 1.88 ± 0.50 ^{a} | 3.48 ± 2.22 ^{a} |
| Hill Landing | | | | | | | | | |
| 8. Pleasant | 6.85 | 1.80 | 1.14 | 0.06 | 4.43 | 38.1 | 5.38 ± 0.53 | 1.41 ± 0.59 | 1.12 ± 0.50 ^{a} |
| Hill Landing | | | | | | | | | |
| (Cypress | | | | | | | | | |
| Swamp) | | | | | | | | | |
| 9. Pole Yard | 7.24 | 1.35 | 0.76 | 0.004 | N.D. | 19.5 | 1.59 ± 0.12 | 1.53 ± 0.50 ^{a} | 2.49 ± 1.23 ^{a} |
| Landing | | | | | | | | | |
| 10. | 7.28 | 353 | 3.07 | 0.02 | N.D. | 43.1 | 2.05 ± 0.09 | 6.50 ± 2.10 | 1.68 ± 0.85 ^{a} |
| McClellanville | | | | | | | | | |

^{a} k_{P} and kₑₓₚ are not statistically different at the 95% confidence level.

These and other modifications and variations to the present invention may be practiced by those of ordinary skill in the art, without departing from the spirit and scope of the present invention, which is more particularly set forth in the appended claims. In addition, it should be understood the aspects of the various embodiments may be interchanged both in whole or in part. Furthermore, those of ordinary skill in the art will appreciate that the foregoing description is by way of example only, and is not intended to limit the invention so further described in the appended claims.

What is claimed:

1. A method of treating fruits and/or vegetables to oxide any organic contaminates thereon, the method comprising:
applying an aqueous solution to an outer surface of the fruits and/or vegetables, wherein the aqueous solution comprises a ferrous salt and an acid;
exposing the aqueous solution to oxygen gas;
allowing the organic contaminates to be oxidized via exposure to the aqueous solution and oxygen gas; and
washing the outer surface of the fruits and/or vegetables to remove the aqueous solution.

2. The method of claim 1, wherein the pH of the aqueous solution is about 4 to about 9.

3. The method of claim 2, further comprising:
adjusting the pH of the aqueous solution.

4. The method of claim 1, wherein the acid comprises a weak acid that is compatible with food stuffs.

5. The method of claim 1, wherein the acid comprises a carboxylic acid, an alcohol, an amino acid, a phosphoric acid, a carbonic acid, or mixtures thereof.

6. The method of claim 1, wherein the acid comprises a carboxylic acid selected from the group consisting of citric acid, acetic acid, formic acid, lactic acid, tartaric acid, ascorbic acid, oxalic acid, and mixtures thereof.

7. The method of claim 1, wherein the acid comprises an alcohol selected from the group consisting ethanol, propanol, isopropanol, and mixtures thereof.

8. The method of claim 1, wherein the ferrous salt comprises iron(II) chloride iron(II) bromide, iron(II) oxide, iron(II) sulfate or its derivatives, hydrates thereof, or mixtures thereof.

9. The method of claim 1, wherein the ferrous salt is present in the aqueous solution in a concentration of about 50 μM to about 1 mM.

10. The method of claim 1, wherein applying the aqueous solution to the outer surface of the fruits and/or vegetables comprises spraying the aqueous solution to the outer surface.

11. The method of claim 1, wherein applying the aqueous solution to the outer surface of the fruits and/or vegetables comprises tumbling the fruits and/or vegetables in a bath of the aqueous solution.

12. The method of claim 1, wherein the outer surface of the fruits and/or vegetables define a waxy skin, a rind skin, or a peel skin.

13. A method of oxidizing organic compounds in an aqueous sample, the method comprising:
measuring the pH of the aqueous sample;
determining an appropriate chemical equation for oxidation based upon the pH measured; and
thereafter, adjusting the pH of the aqueous sample.

14. The method of claim 13, further comprising:
after adjusting the pH, exposing the aqueous sample to oxygen.

15. The method as in claim 13, wherein the appropriate chemical equation is determined to be equation number 18 discussed above.

16. The method as in claim 13, wherein the appropriate chemical equation is determined to be equation number 19 discussed above.

17. The method as in claim 13, further comprising:
measuring the concentration of Cl⁻ in the aqueous sample.

18. The method as in claim 13, further comprising:
measuring the concentration of Fe(II) in the aqueous sample.

19. The method as in claim 13, further comprising:
measuring the concentration of CO₃²⁻ in the aqueous sample.

20. The method as in claim 13, further comprising:
measuring the concentration of PO₄³⁻ in the aqueous sample.
